(19) United States
(12) Patent Application Publication
(10) Pub. No.: US 2020/0359845 A1
(43) Pub. Date: Nov. 19, 2020

(54) COOKING ROBOT FOR THE HOME

(71) Applicant: Cohan Sujay CARLOS, Bongalore (IN)

(72) Inventors: Cohan Sujay CARLOS, Bongalore (IN); Arpit SHARMA, Karauli (IN)

(21) Appl. No.: 16/762,950

(22) PCT Filed: Nov. 15, 2018
(86) PCT No.: PCT/IN2018/050754

§ 371 Date: May 11, 2020

(30) Foreign Application Priority Data
Nov. 15, 2017 (IN) 201741040810
Jan. 11, 2018 (IN) 201841001318

(51) Int. Cl. A47J 44/00; A47J 36/32; A47J 36/38; A47J 36/06; A47J 43/04; A47J 27/00

(52) U.S. Cl. CPC A47J 44/00; A47J 36/321; A47J 36/38; A47J 2201/00; A47J 43/04; A47J 27/004; A47J 36/06

(57) ABSTRACT

A remotely controllable and programmable apparatus for the preparation of a set of cooked dishes contains storage containers for holding ingredients for use in the preparation of cooked dishes, each with an ingress orifice near the upper end through which ingredients can be loaded into the storage containers and an egress orifice near the lower end through which ingredients can be made to fall out by ingredient dispensers attached thereto. The apparatus contains cooking receptacles that hold ingredients while they are being heated in the course of cooking. An arm actuator of the apparatus is operable to drive a transport arm only along a horizontal plane to minimize power consumption in conveying ingredients from a container to a cooking receptacle.

### PRIORITY CLAIM AND RELATED APPLICATIONS

The instant patent application claims priority from co-pending India provisional patent application entitled, “Apparatus For Dispensing Solid Food Ingredients Which Is Suitable For Use In A Cooking Robot”, Application Number: 201741040810, Filed: 15 Nov. 2017, naming Cohan Sujay Carlos and Arpit Sharma as the inventors, attorney docket number AIAI-302-INPR, and is incorporated in its entirety herewith, to the extent not inconsistent with the content of the instant application.

The instant patent application claims priority from co-pending India provisional patent application entitled, “Simple Cooking Robot For The Automatic Preparation Of Multiple Dishes”, Application Number: 201841001318, Filed: 11 Jan. 2018, naming Cohan Sujay Carlos and Arpit Sharma as the inventors, attorney docket number AIAI-303-INPR, and is incorporated in its entirety herewith, to the extent not inconsistent with the content of the instant application.

### 1. OVERVIEW

An aspect of the present disclosure concerns a remotely controllable and programmable apparatus for the preparation of a set of cooked dishes, comprising a plurality of storage containers for holding ingredients for use in the preparation of cooked dishes each with an ingress orifice near the upper end through which ingredients can be loaded into the storage containers and an egress orifice near the lower end through which ingredients can be made to fall out by ingredient dispensers attached thereto, cooking receptacles that hold ingredients while they are being heated in the course of cooking, transport containers on arms (moving in horizontal planes) that receive the ingredients as they fall out from storage containers by the action of the ingredient dispensers and convey them to cooking receptacles, heaters to heat the cooking receptacles, manipulators (such as stirrers, whisks, scoops, sieves, grinders, mincers, mixers, washers, rinsing mechanisms or blenders) to manipulate the ingredients in order to prepare them for cooking, a controller that controls said heaters, manipulators and actuators, a communication system configured to allow the user to communicate with said controller. The arm is designed to be moved only along a horizontal plane (either a rotary movement or a linear movement), thereby requiring less power and lowering costs and sizes. The movements of the transport arm can position transport containers/chutes below storage container so that the ingredients dispensed from the storage containers fall into the transport container without having to be lifted against the force of gravity. The movements of the transport arm or another transport arm in a different plane are capable of bringing the transport container or one end of a chute above a cooking receptacle so that the ingredients fall into that cooking receptacle without having to be lifted against the force of gravity. The machine is designed so that the storage containers, ingredient dispensers, cooking receptacle, transport container (or chute) and manipulator (basically any part of the machine that comes into contact with food) are all easily detachable for cleaning. The motors and other actuators driving the dispensers, manipulators, heaters, and other parts of the cooking apparatus in this disclosure can be controlled by microprocessors which can be programmed to automatically cook a number of a selection of dishes sequentially and simultaneously, and which can communicate with a remote device such as a mobile phone allowing for the controlling, customization and monitoring of the cooking process.

### 2. BACKGROUND

The disclosure concerns an apparatus for the preparation of multiple cooked dishes that is convenient, cheap enough, reliable, small, robust and safe enough for use in homes.

The preparation of cooked dishes generally takes place in two stages, the first stage being the preparation of individual ingredients, and the second stage being the timed addition and mixing in of different ingredients, the application of heat, the stirring of the mixed ingredients, agitation of the mixed ingredients using a whisk and other handling steps that constitute the process of cooking.

Many known types of cooking appliances are limited to the first stage in which ingredients are prepared, whereas the invention deals primarily with the second stage comprising the steps of mixing of multiple ingredients and the further handling steps that constitute the process of cooking.

Moreover, one known type of cooking appliance concerned with the second stage of cooking comprising compartments holding the ingredients and a means for transferring them to a cooking receptacle positioned below said compartments is limited to the cooking of only one dish at a time. The invention deals with a means of preparing multiple dishes as required for Indian cooking wherein a meal comprises one or more main dishes and a plurality of side dishes.

The totality of the appliance functions, including the sequence and quantities of addition of ingredients, and the sequence and duration of cooking of various dishes, and the transfer of partially cooking dishes from one cooking receptacle to another, as is required in Indian cooking, is governed by a programmable automated system and is possible to monitor remotely through a remote viewing device such as a mobile phone.

One drawback of known appliances such as the one described in U.S. Pat. No. 5,819,636 is that they use only one cooking receptacle and therefore are incapable of the cooking of a set of dishes that constitute a meal according to Indian cuisine. Another drawback is that a fully enclosed design does not allow for the escape of fumes produced in the process of cooking, notably during cooking with oil, and hinders the draining of excess fluids from the cooking receptacles, also required for some steps in Indian cooking, and the straining and transfer of partially cooked ingredients from one cooking receptacle to another.

Yet another drawback of known appliances, as seen in U.S. Pat. No. 4,503,502 is that the design does not allow for easy detachment of components which come into contact with the ingredients of the dishes, thereby making the cleaning of the components a very onerous process.

Another known appliance that is designed for the preparation of multiple dishes is that described in U.S. Pat. No. 7,174,830. One drawback of such a design is the cost, unreliability and excessive power consumption that invariably attend the manipulation of dishes by lifting them vertically. This drawback attends any and all designs that depend on a manipulator arm to move heavy objects vertically against the force of gravity.

Another known appliance that is designed for the preparation of multiple dishes is that described in U.S. Pat. No. 8,276,505. This appliance also has a manipulator arm that scoops out ingredients from storage containers and deposits them in cooking receptacles. This has two problems, firstly, that the ingredients become difficult to measure either by volume or by weight, or require too many passes with the manipulator to measure out, and secondly, that the manipulator arm in moving vertically to lift ingredients out of their storage containers, wastes considerable energy.

### 3. BRIEF SUMMARY OF THE INVENTION

According to an aspect of the present disclosure a cooking apparatus comprises multiple storage containers for storing ingredients, and one or more cooking receptacles in which the application of heat during cooking takes place. It also comprises one or more transport arms moving in horizontal planes. On each transport arm is mounted at least one transport container which receives, under programmatic control, ingredients from the storage containers (possibly equipped with a cooling system to preserve perishable ingredients or a heating system to decrease the viscosity of ingredients such as ghee or coconut oil) and conveys them to the cooking receptacles or to transport containers or manipulators mounted on transport arms operating in lower horizontal planes. The cooking receptacles can have suitable lids (either simple lids or pressure lids) which can be closed when required, and can be heated by the heaters, again under programmatic control, to cook (heat, boil, fry, bake, steam, pressure cook etc.) the ingredients deposited in them.

In an embodiment, the cooking apparatus is capable of cooking multiple dishes simultaneously. The storage containers have an egress orifice (output opening, in general) through which ingredients may fall out under the action of ingredient dispensers which have obstructions that can be programmatically removed by an obstruction actuator mounted on the movable transport arm. Ingredients may be loaded into the storage container through an ingress orifice (input opening, in general, which may be the same as the egress orifice with the storage container being held upside down) possibly assisted by the user interface directing the user as to where to load what. An embodiment may also comprise manipulators (such as a stirrer, a whisk, a scoop, a sieve, a grinder, a mincer, a mixer, a washer, a rinser or a blender) mounted on manipulator arms or on the transport arms, capable of processing ingredients in myriad ways (stirring, whisking, scooping and releasing, sieving, grinding, mincing, mixing, washing, rinsing or blending them). The manipulators may process ingredients in the transport container on the transport arm, or may take ingredients within themselves and operate on them before transferring the processed ingredients back to the transport arm or directly to the cooking receptacle, or they may process the ingredients directly in the cooking receptacle.

One of the aims of the invention is to propose a cost-effective solution that is affordable to home users. To that end, the movements of the arms are in horizontal planes, enabling the machine to operate using less powerful motors (saving costs, energy and space).

Another of the aims of the invention is to propose a solution that is easy to clean. So it features a simplified arrangement of storage containers, ingredient dispensers, cooking receptacles, transport containers and manipulators so that they are all easily detachable from the rest of the machine for cooking food so as to facilitate their cleaning.

Another aim of the invention is to propose a programmable, remotely controllable apparatus that is adequate to the task of cooking more than one dish from a broad range of dishes from North Indian, South Indian, European, African and Asian cuisines. To that end, an aspect of the present invention contains a microcontroller that enables the user to construct recipes or modify recipes, and to select the dishes to be prepared, through a user interface. It then performs a sequence of actions from an adequate vocabulary of ingredient dispensing, heating and manipulating actions. In one aspect, the invention is remotely controllable so that the cooking process can be initiated and monitored even when a human is not near the cooking apparatus.

Yet another aim of the invention is to reduce the time spent on cooking chores by simplifying chores such as cleaning by making the parts of the apparatus most liable to come into contact with cooking ingredients detachable and easily amenable to extraction for washing, and automatically detachable and transportable to a cleaning area, as well as self-cleaning where possible.

In some embodiments, the machine for cooking food automatically further comprises at least one physical grouping of containers, wherein the physical grouping of containers is easily detachable from the machine for cooking food. This makes it easier to remove the containers after cooking and to load ingredients into the machine before the preparation of dishes begins. The physical grouping of containers may carry position indicators (such as LEDs (light-emitting diodes), position markers, or automatic lid opening mechanisms) to help identify the ingredient containers that ingredients need to be loaded into at the time of loading of the ingredients.

In some embodiments, the machine for cooking food also comprises a weight sensor which is interposed between the transport container and the transport arm so that it can weigh the ingredients dispensed into the transport container. However, since the transport container must be detachable to permit its easy cleaning, there is also a loose coupling to connect the transport container to the weight sensor allowing the sensor to be parked and protected when it comes time to detach the transport container from the transport arm.

In some embodiments, the machine for cooking food automatically further comprises a housing designed to prevent the unintended contact of parts of the machine with undesirable things including dust, insects, animals and young humans, and at least one fan configured to evacuate the fumes and vapours produced in the process of cooking, and draw in fresh air.

In some embodiments, the movements of the transport arm and/or manipulator arm in the machine for cooking food automatically are in the horizontal plane and consist of rotary movements about at least one rotating joint.

In some embodiments, the movements of the transport arm and/or manipulator arm in the machine for cooking food automatically are in the horizontal plane and consists of linear movements along two axes.

In some embodiments of the machine, the manipulator is a scoop configured to transfer the ingredients in the cooking receptacles from one cooking receptacle to another (scooping from one and releasing them into another).

In some embodiments, the machine further comprises a rinsing mechanism designed to clean ingredients such as grains and pulses before use in cooking.

In some embodiments, the machine further comprises a container that drains fluids used to store solid ingredients that need to be stored soaked in said fluid, before the use of said solid ingredients in cooking.

In some embodiments, the machine further comprises lids for pressure cooking, steaming and baking.

In some embodiments, the machine further comprises a box for storing and breaking eggs.

In some embodiments, the user can communicate with the machine from a considerable distance from the food processor (possibly using their phone or smart watch or other communicate device).

In some embodiments, the machine further comprises at least one sensor configured to measure various physical parameters related to the cooking process, such as temperatures, pressures, gaseous emissions and visual appearances.

In some embodiments of the machine the manipulator can be interposed between the transport container and the cooking receptacle so that the ingredients are first dispensed from the transport container into the manipulator and suitably manipulated before being allowed to fall from the manipulator into a cooking receptacle or a transport container.

In some embodiments of the machine, the manipulator (such as a stirrer, whisk or blender) can dipped into a cooking receptacle so that the ingredients are manipulated while contained within the cooking receptacle.

In some embodiments of the machine, the manipulator (such as a stirrer, whisk or blender) can dipped into a transport container so that the ingredients are manipulated while contained within the transport container.

In some embodiments, the machine further comprises a spill/splash guard that collects ingredients being spilt or splashed and preventing the spilt ingredients from entering any of said at least one cooking receptacle which they are not intended to enter.

In some embodiments, the machine comprises a cooling system to keep ingredients in ingredient containers or a physical grouping of ingredient containers at a lower temperature than room temperature.

In some embodiments, the machine comprises a heating system to heat ingredients in ingredient containers or a physical grouping of ingredient containers.

In some embodiments of the machine, the transport arm comprises at least one locking mechanism for fixing itself rigidly in a certain position so that the actuator driving the movable transport arm does not have to do the work of keeping it in position.

In some embodiments, the machine further comprises a loading mechanism configured to bring unused cooking receptacles into the machine and remove used cooking receptacles from the machine.

In some embodiments, the machine further comprises a pump or siphon to drain fluids from the cooking receptacles.

In some embodiments, the machine is modular and the main components such as the controller (the brain), the stirrers, the heaters and the housing containing the ingredient storage and dispensing subsystem can be sold separately and assembled into one machine, one by one.

In some embodiments, the machine further comprises a recording mechanism to record cooking instructions to be given to it by voice or through a communication device (such as a phone or attached user interface) and transform such instructions into a recipe that users can share and any similar machine can execute. The machine can also be part of a social network of similar machines allowing users to collaborate and to cook dishes remotely.

### 4. BRIEF DESCRIPTION OF THE DRAWINGS

The following description of an embodiment of the invention will be rendered more comprehensible when read in reference to the attached drawings, among which:

FIG. 1 is a depiction of an embodiment of the arrangement of storage containers and cooking receptacles in the machine for cooking food according to the invention;

FIG. 2 is a depiction of an embodiment of the ingredient dispensers associated with storage containers of solid ingredients and the dispenser actuators.

FIG. 3 is a depiction of an embodiment of the ingredient dispensers associated with storage containers of liquid ingredients and the dispenser actuators.

FIG. 4 is a depiction of an embodiment of the physical grouping of containers of ingredients.

FIG. 5 is a depiction of an embodiment of a manipulator which handles ingredients in a cooking receptacle.

FIG. 6 is a depiction of an embodiment of a manipulator, which can be interposed between a transport container and a cooking receptacle.

FIG. 7 is a depiction of an embodiment of a transport arm bearing a transport container from where ingredients are dispensed to the cooking receptacle to which they are destined.

FIG. 8 is a depiction of an embodiment of a transport arm.

FIG. 9 is a depiction of an embodiment of a spill guard.

FIG. 10 is a depiction of an embodiment of a pressure cooking, steaming and baking lid.

FIG. 11 is a depiction of an embodiment of a container in which eggs can be stored and broken when needed in cooking.

FIG. 12 is a depiction of an embodiment of a communication system used to communicate with a user, optionally using a remote interface.

FIG. 13 is a depiction of an embodiment of a loading mechanism for bringing unused cooking receptacles into the machine and removing used cooking receptacles from the machine.

FIG. 14 is a depiction of an embodiment of a rinsing mechanism for ingredients such as grains and pulses that need to be washed before being used in cooking.

FIG. 15 is a depiction of an embodiment of an ingredient dispenser for storing solid ingredients that need to be stored soaked in a fluid before use in cooking.

FIG. 16 is a depiction of embodiments of sensors for measuring quantities (by volume or weight) of food ingredients to be dispensed.

FIG. 17 is a depiction of the details of one embodiment of the obstruction component of one embodiment of the ingredient dispenser.

FIG. 18 illustrates an embodiment of a mechanism for dropping controlled or uncontrolled quantities of food ingredients.

FIG. 19 illustrates an embodiment of yet another type of ingredient dispenser that uses pressurized air for dispensing quantities of food ingredients that might be difficult to dispense only with the assistance of gravity.

FIG. 20 illustrates another embodiment of a rinsing mechanism for ingredients such as grains and pulses that need to be washed before being used in cooking.

FIG. 21 illustrates an embodiment of yet another type of ingredient dispenser 103 that uses negative air pressure (suction) for dispensing quantities of food ingredients that might be difficult to dispense only with the assistance of gravity.

FIG. 22 illustrates a system for grinding ingredients.

FIG. 23 illustrates a container storage module where clean transport containers can be stored until they are needed and soiled transport containers can be deposited.

FIG. 24 describes an embodiment of the fan installed in the housing to evacuate fumes produced during cooking.

### 5. DETAILED DESCRIPTION OF THE INVENTION

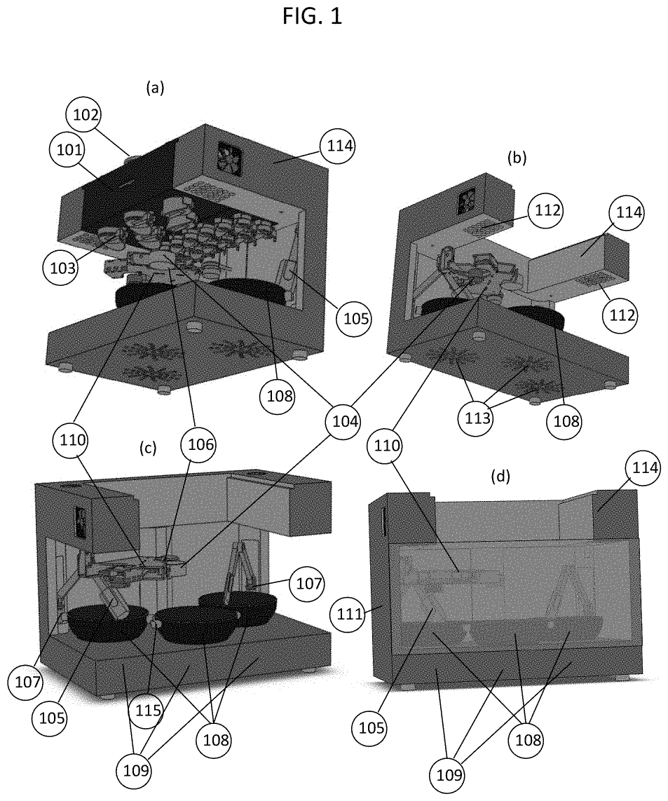

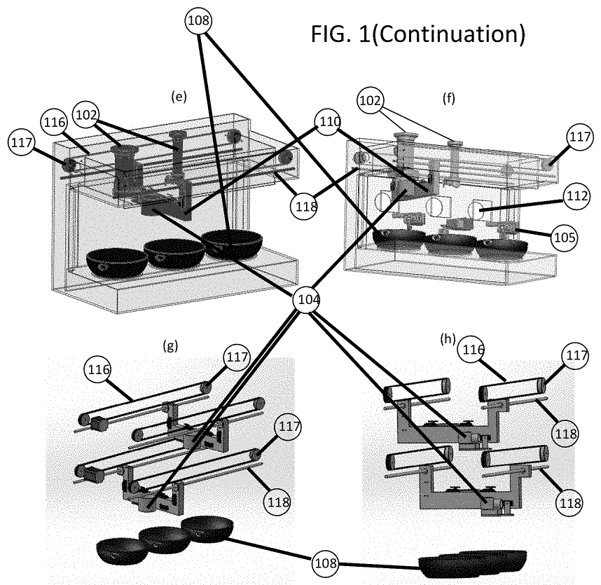

FIG. 1 illustrates an embodiment of a machine for the preparation of a plurality of dishes featuring at least one cooking receptacle 108 for cooking food, and at least one ingredient container 102 for holding ingredients arranged in physical groups 101 above the cooking receptacles. Ingredient dispensers 103 fitted to the storage containers 102 for ingredients and driven by one or more dispenser actuators 106 (embodiments of which include linear actuators, rotary actuators, motors and electrical power sources, and which are arranged on a movable transport arm 110) dispense ingredients into the transport container 104 which conveys the dispensed ingredients to the cooking receptacles 108 arranged below, in the proper sequence required for cooking. Heat for cooking is supplied by the heaters 109 located below the cooking receptacles 108. The dishes are stirred by suitable manipulators (here stirrers) 105 driven by suitable actuators 107 located on or at the end of the movable manipulator arm 110 on which the manipulator 105 is also mounted.

FIG. 1A, FIG. 1B and FIG. 1C show the isometric views of one embodiment of the machine for cooking food automatically with parts of the housing 111 (namely the front and side covers) not present. The housing 111 is designed to prevent the unintended contact of parts of the machine with undesirable things including dust, insects, animals and young humans, whereas FIG. 1D is the isometric view of an embodiment of the machine for cooking food automatically equipped with the full housing 111, (parts of which are transparent to allow a user to view the cooking process), the fans for evacuating 112 fumes and vapours produced by the cooking process, and the fans for drawing in fresh air 113.

It will be apparent to those skilled in the art that the storage containers 102 can be supported above the cooking receptacles 108 by means of any suitable supporting structure, one embodiment thereof being a pillar, another embodiment being multiple pillars, still another embodiment being walls and yet another embodiment being a cantilevered support such as the roof of an enclosure. It will also be apparent to those skilled in the art that the three cooking receptacles 108 herein shown is not a limitation and represents any number of cooking receptacles. It will also be apparent to those skilled in the art that the physical grouping of containers 101 shown in FIG. 1A (which has been removed for clarity from FIGS. 1B to 1C) is likewise not limited to the number of containers or the arrangement thereof shown in FIG. 1A. It will also be apparent to those skilled in the art that the positions of the fans can vary from what is shown in the figures and said fans may be mounted at the back of the body or at the sides, and that air may be drawn in through holes in the housing either at the front or sides or in any other suitable direction. It will also be apparent to those skilled in the art that the transport arms need to move in a horizontal plane to be energy efficient when they carry heavy ingredients because of consequent load changes and that some manipulator arms may not have to move in a horizontal plane for efficiency (if the weight of the manipulator carried on the arm and the weight of the arm with its actuators is low or remains constant so that it can be easily balanced out using a suitable static counter-weight).

FIGS. 1A to 1D illustrate an embodiment of the machine employing a transport arm 110 capable of rotary motion around hinges in the horizontal plane. FIGS. 1E and 1F illustrate an embodiment of the machine employing a transport arm 110 capable of linear motion along guide-rails 118 in the horizontal plane, actuated by belts 116 and pulleys 117. FIGS. 1G and 1H illustrate an embodiment of the machine employing multiple transport arms 110 each moving in its own plane such that each can transfer ingredients from its own transport container or manipulator to a lower transport arm or to the cooking receptacle, and accept ingredients into its own transport container or manipulator from a higher transport arm or the storage containers. In some embodiments of the machine, the transport containers carried upon the transport arms can tilt in the direction of acceleration (while the arms accelerate horizontally) so that the ingredients contained within them do not spill while being conveyed to their destination. In some other embodiments of the machine, the transport containers carried upon the transport arms have lids to keep their contents from spilling while being transported.

The ingredients can be kept cool by a cooling system 114 in the machine or kept warm by a heating system 114 in the machine. In some dishes, water will need to be drained out of the cooking receptacle 108 after cooking. This can be done using a pump or siphon 115 (the opening for which is shown at the edge of the cooking receptacle 108 in FIG. 1C).

The operation of the cooking apparatus according to FIG. 1 is now described using an example of South Indian cooking. A typical South Indian meal consists of a serving of rice, something wet to go with the rice (such as a rasam) and something dry (for example, a potato fry). We now describe the process of cooking a serving of rice, a rasam and a potato fry with reference to FIG. 1.

The ingredients needed for the rice dish are water and rice. Suitable quantities (200 ml of rice and 4 cups of water) are stored in large sized storage containers 102.

The ingredients for rasam are cut tomatoes (500 ml) and water (3 cups) which are stored in large sized solid storage container 102, and also small quantities of salt, rasam powder, curry or mint leaves (16 leaves), hing (asafoetida), mustard, cumin, fenugreek and oil (1 tbsp) which are stored in the small storage containers 102.

The ingredients for the potato fry are 2 potatoes diced into small cubes, salt, mustard, cumin, fenugreek, red chilli powder, turmeric powder, asafoetida (hing), oil and water which can be stored in large and small storage containers 102.

The cooking starts with a transport arm 110 bearing a dispenser actuator 106 and a transport container 104 moving horizontally till it is under the large storage container 102 containing the rice. The ingredient dispenser for solids 103 is now driven by the dispenser actuator 106 so that the rice is dispensed into the transport container 104. Now, the transport arm 110 carrying the transport container 104 moves horizontally till it is positioned over the first cooking receptacle 108. Now, the transport container 104 releases the ingredients it contains into the first cooking receptacle 108 over which it is positioned.

Now the arm 110 is rotated till the transport container 104 is positioned under the large sized container 102 for water. The ingredient dispenser 103 is now driven by the dispenser actuator 106 so that the water is dispensed into the transport container 104. Now, the transport arm 110 carrying the transport container 104 moves horizontally till it is positioned over the first cooking receptacle 108. Now, the transport container 104 releases the water it contains into the first cooking receptacle 108 over which it is positioned.

In other embodiments of this machine for cooking food automatically, some ingredients such as water can be dispensed directly into the cooking receptacles below them. In those embodiments, the arm 110 is moved horizontally till the dispenser actuator 106 is positioned at the ingredient dispenser 103 of the storage container for water 102, which is over the first cooking receptacle 108. The ingredient dispenser 103 is now driven by the dispenser actuator 106 so that the water is dispensed into the cooking receptacle 108.

Now the heater 109 under the first cooking receptacle 108 containing the rice and the water is activated. The heat supplied by heater 109 cooks the rice in the first cooking receptacle 108.

While the rice is cooking, the preparations for the rasam begin in the second cooking receptacle. The arm 110 is moved horizontally to the storage container 102 containing a cooking oil and the ingredient dispenser 103 on the storage container is operated by the dispenser actuator 106, dispensing a few tablespoonfuls of oil into the transport container 104 which releases them into the second cooking receptacle 108. The heater 109 under the second cooking receptacle 108 is activated. Similarly, arm 110 is moved horizontally to the storage containers 102 with cumin, mustard and fenugreek seeds and small quantities of their contents are dispensed into the transport container 104 and thence into the second cooking receptacle 108. After a certain amount of time (sufficient for the seeds to begin to sputter), the arm 110 is moved horizontally to the storage containers for hing and curry leaves one by one and their contents collected and conveyed by the transport container 104 to the second cooking receptacle 108. The contents are allowed to fry for a minute. Then the arm 110 is moved horizontally to the large storage container 102 containing the finely chopped tomatoes and these contents conveyed into the cooking receptacle 108. Similarly, suitable amounts of the contents of the storage containers for salt and turmeric are dispensed into the second cooking receptacle 108. The contents of the second cooking receptacle 108 are fried for about 2 minutes. The arm 110 is moved horizontally to the large storage container 102 containing water and the water is likewise dispensed into the cooking receptacle 108. The transport arm 110 is now moved horizontally to the storage container with the rasam powder and the rasam powder is conveyed into the cooking receptacle 108. After 5 minutes of cooking, the rasam will be ready in the second cooking receptacle.

While the rasam is thus being cooked, the preparations for making the potato fry commence in the third cooking receptacle. The arm 110 is moved horizontally to the storage container 102 containing a cooking oil and the ingredient dispenser 103 on the storage container is operated by the dispenser actuator 106, dispensing a few tablespoonfuls of oil into the transport container 104 which releases them into the second cooking receptacle 108 and the heater 109 under the second cooking receptacle 108 is activated. Similarly, the transport arm 110 is moved horizontally to the storage containers with cumin, mustard and fenugreek seeds and small quantities of their contents are dispensed into the transport container 104 and thence into the second cooking receptacle 108. After a certain amount of time (sufficient for the seeds to begin to sputter), the storage containers for hing and turmeric rotate over the same spot one by one and dispense their contents. After a minute, the transport arm 110 is moved horizontally to the large storage container 102 containing potatoes and the potatoes are conveyed to the third cooking receptacle 108. The potatoes are fried in the spices for 3 minutes in the third cooking receptacle 108. Finally, the arm 110 moves horizontally to the storage containers for salt and red chilli powder and conveys finely controlled quantities of their contents to the third cooking receptacle. The manipulator 105 which is a manipulator (stirrer) and is powered by the manipulator actuator 107 is used to stir the potatoes from time to time till they are crisp and done.

After an adequate period of applying heat to the first, second and third cooking receptacles 108 by a suitable number of heaters 109, the rice will be ready in the first cooking receptacle and can be eaten with the rasam that stands ready in the second cooking receptacle (the rasam is poured onto the rice at the time of eating). The rice and rasam will be eaten with helpings of potato fry from the third cooking receptacle.

Thus, we have illustrated using an example of South Indian cooking, the operation of the cooking apparatus according to FIG. 1.

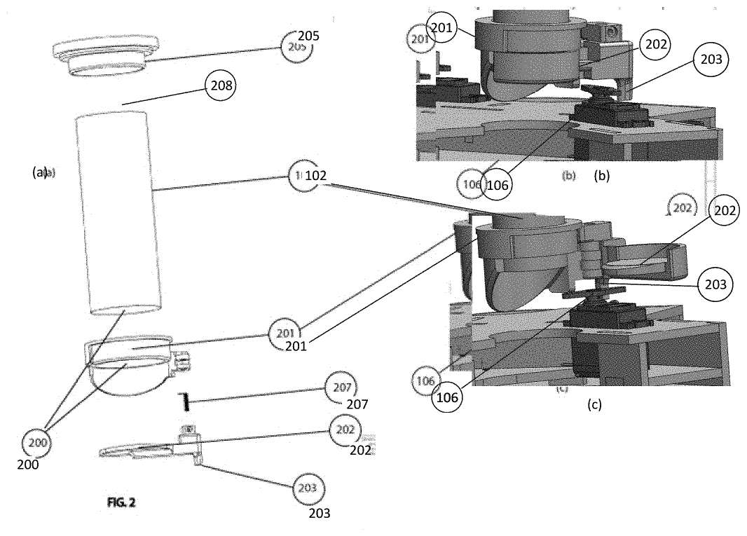

The mechanical details of an embodiment of the machine for cooking food automatically will now be described with further reference to FIGS. 2-6.

FIG. 2 illustrates an embodiment of a mechanism (also called an ingredient dispenser 103) for dropping controlled or uncontrolled quantities of solid food ingredients featuring a storage container 102 with an ingress orifice 208 (or input opening, in general) through which ingredients can be loaded into the storage container, an egress orifice 200 (or output opening, in general) at its lower end, at which orifice can be found a collar 201 for attaching to the storage container a removable obstruction 202 (in this case a lid) which keeps the ingredients placed in the storage container from falling out until said lower obstruction is displaced. The obstruction is kept in its obstructing position by a spring 207 and can be opened by a handle for opening 203 the same. The handle for displacing/removing the obstruction 203 can be operated by a dispenser actuator 106 such as a motor or a solenoid. The obstruction 203 is kept in place by a spring 207 (which is inserted between the obstruction 202 and the storage container's collar 201). The said obstruction 202 can be opened by a handle 203 with a protrusion against which the arm of a dispenser actuator 106 (such as a motor) can be opposed. The force exerted by the dispenser actuator 106 can cause in the case of a rotary handle 203 (as in this depiction), the arm holding the obstruction 202 to pivot about the axis of a hinge and the spring 207 (in the case of a linear obstruction, it would cause the obstruction to slide along a groove), in any case resulting in the obstruction being displaced so that it no longer obstructs the egress orifice 200 at the lower end of the storage container 102. When the force exerted by the dispenser actuator 106 is removed, the spring 207 returns the obstruction to its obstructing position. It will be apparent that an active actuator can be used in place of the spring 207 to return the obstruction to its obstructing position and hold it there or lock it in place.

In this design, dispenser actuator 106 can be easily separated from the rest of the ingredient dispenser 103 as it is in no way tethered to the rest of the ingredient dispenser, and only needs to come in contact with the rest of the ingredient dispenser when displacing the obstruction using the handle 203, as can be seen from FIGS. 2B and 2C which depict the obstruction both when obstructing/closed (2B) and not-obstructing/open (2C). The sleeve 205 may be required to position the ingredient dispenser firmly in its place in a cooking robot while allowing the unimpeded insertion of the ingredient dispenser into the cooking robot. It will be apparent to those skilled in the art that the sleeve 205 can be positioned on the side should the ingredient dispenser be designed to be removed from the side of a cooking robot, or at the bottom should that be the preferred side from which the ingredient dispenser is to be removed. It will also be apparent to those skilled in the art that storage containers 102 may also be designed in such a way as to not be possessed of a separate ingress orifice for loading contents but that they may be turned upside down and the egress orifice used as the ingress orifice in that position.

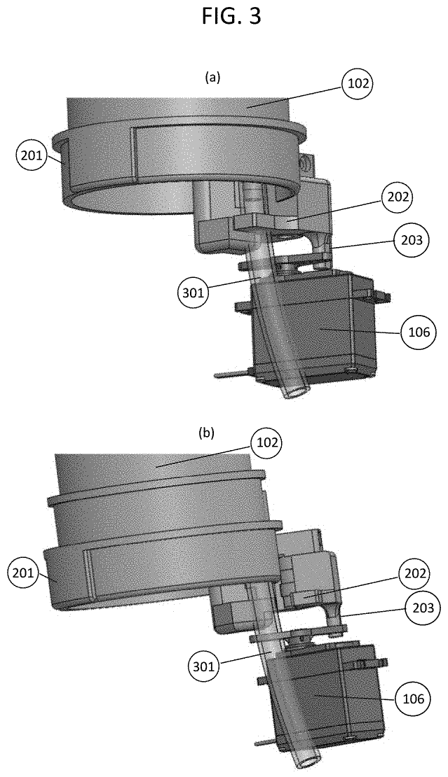

FIG. 3 illustrates an embodiment of an ingredient dispenser 103 for dropping controlled or uncontrolled quantities of liquid food ingredients featuring a storage container 102 which is capable of containing the liquid food ingredient, upon which can be found a collar 201 for attaching to the storage container a passage for the flow of liquids under the influence of gravity 301, and an obstruction 202 which keeps the liquid ingredients in the storage container from flowing out (as shown in FIG. 3A) until the obstruction is displaced so that it no longer obstructs the flow of liquids as shown in FIG. 3B. The obstruction is kept in place by a spring 207 and can be displaced by a handle 203. The handle 203 can be operated by a dispenser actuator 106. In this design, said dispenser actuator 106 can be easily separated from the rest of the ingredient dispenser 103 as it is in no way tethered to the rest of the ingredient dispenser, and only needs to come in contact with the rest of the ingredient dispenser when displacing the obstruction using the handle 203, as can be seen from FIGS. 3A and 3B.

It may also be noted that if the storage containers and ingredient dispensers are held such that they cannot move freely in certain directions in the horizontal plane, they can be removed from the machine and replaced in the machine without the need for any kind of latch, because the movement of the dispenser actuator 106 is in a restricted arc in the horizontal plane. Thus FIG. 2 and FIG. 3 together show how the storage containers and their ingredient dispensers (both of which come into contact with food ingredients) have been designed to be easy to separate from the rest of a cooking machine (and hence easy to clean).

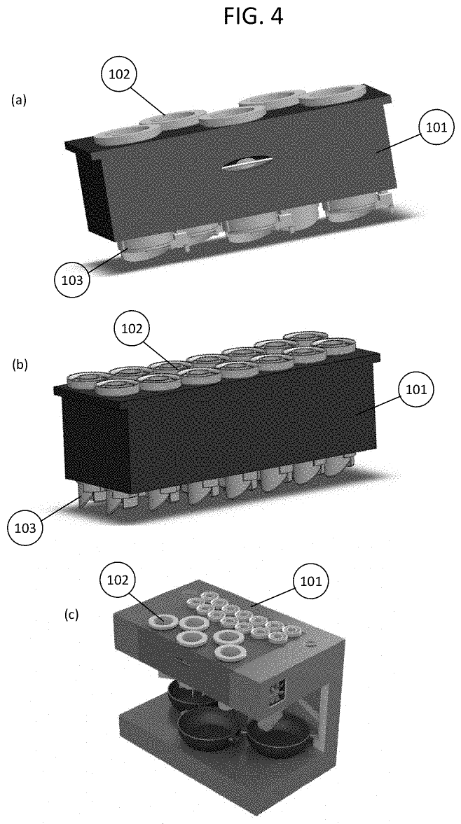

FIG. 4 illustrates an embodiment of a physical grouping 101 of storage containers 102 where the physical grouping is a frame, rack or shelf upon which can be arranged various large storage containers for ingredients 102 along with their ingredient dispensers 103, as shown in FIG. 4A or several small storage containers 102 and their ingredient dispensers 103 as shown in FIG. 4B. The storage containers 102 with their ingredient dispensers 103 can be slotted into the physical groupings 101 either from the top or from the sides so that their ingredient dispensers 103 are disposed either below or to the sides so that dispensed ingredients may fall vertically down from the ingredient dispensers 103. Physical groupings 101 of ingredient dispensers can be fitted into the machine for cooking food automatically by being slid into the same and locked in place with a suitable latch. Thus the physical groupings 105 of the storage containers which comes into contact with the food ingredients are easily detachable from the rest of the machine. FIG. 4C shows physical groupings 101 of storage containers 102 in place in the machine for cooking food automatically.

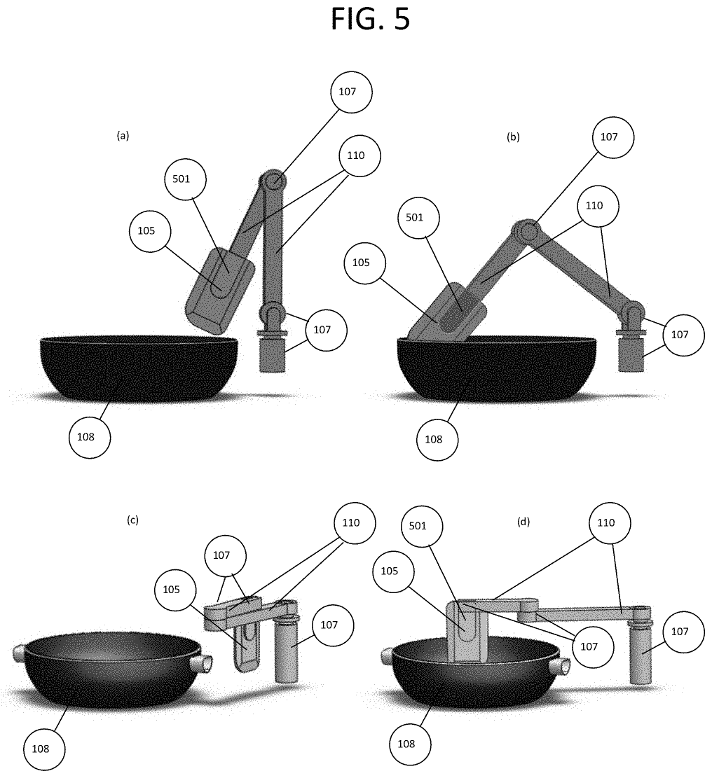

FIG. 5 illustrates a number of embodiments of manipulators 105 which are disposed upon a transport arm or manipulator arm 110 and driven by various arm actuators 107. In one embodiment, the manipulator 105 is a stirrer, and it stirs ingredients in a cooking receptacle 108. FIG. 5A shows the stirrer as it looks when folded and out of the way. FIG. 5B shows the stirrer extended as it would be when handling ingredients in the cooking receptacle 108. The manipulator arm 110 of FIGS. 5A and 5B does not move in a horizontal plane and is therefore not very efficient. FIGS. 5C and 5D show a different type of transport arm or manipulator arm 110, in this case an arm whose hinges have vertical axes and whose movements are entirely in the horizontal plane (such an arm has the advantage of being capable of manipulating a heavier load more efficiently without counter-weights), in both the folded and extended positions. It will be apparent to those well-versed in the art that the manipulator 105 need not be confined to any of the items depicted in this drawing but may also be a means for whisking, whipping, crushing, blending, sieving, scooping or any other such suitable operation. The manipulator 105 is detachable from the arm 110 by a suitable attachment 501 an embodiment of which (in this case a protrusion on the arm which fits tightly into a cavity in the manipulator allowing for the two to be press-fit together) is depicted in FIG. 5.

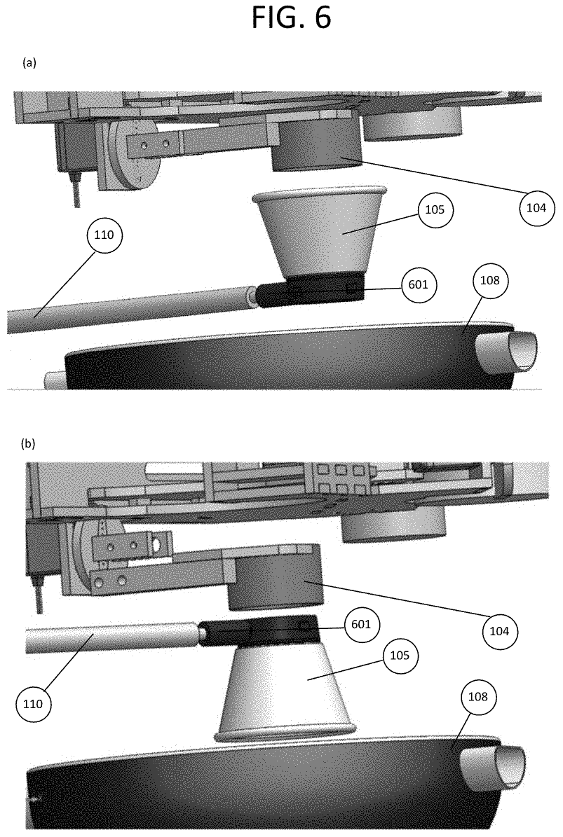

FIG. 6 describes an embodiment of a manipulator 105 which is disposed upon a transport arm 110 and into which ingredients are disposed to be manipulated. In the illustrated embodiment, the manipulator 105 is a grinder which receives ingredients (as shown in FIG. 6A) from the transport container 104. The manipulator 105 (the grinder in this case) then handles the ingredients within itself, and then releases (as shown in FIG. 6B) the handled ingredients into the cooking receptacle 108. The means of handling 105 is detachable from the transport arm or manipulator arm 110 through an attachment 601 that permits quick release of the attached part, an embodiment of which is depicted in FIG. 6. Thus the manipulators 105 (which comes into contact with the food) in both FIG. 5 and FIG. 6 are easily detachable from the arm 110 which carries them, and thus from the rest of the machine.

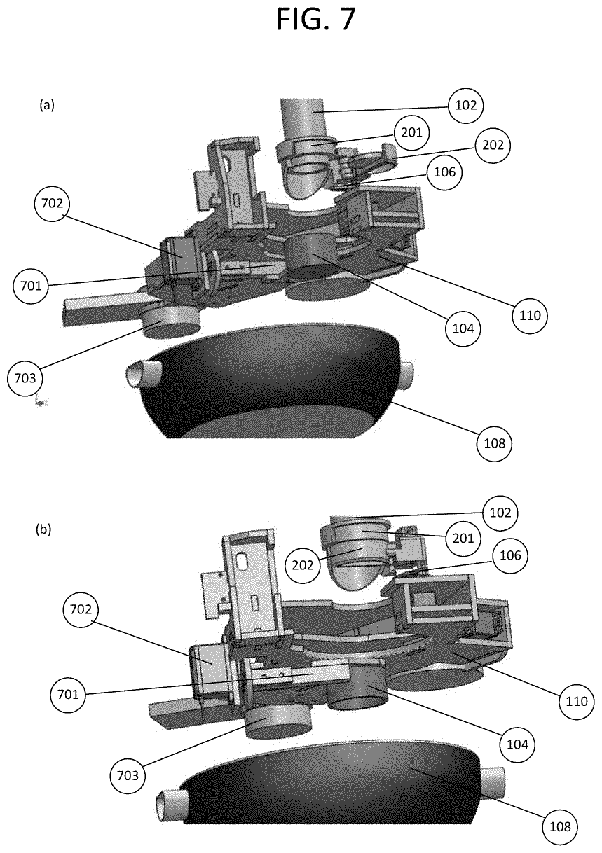

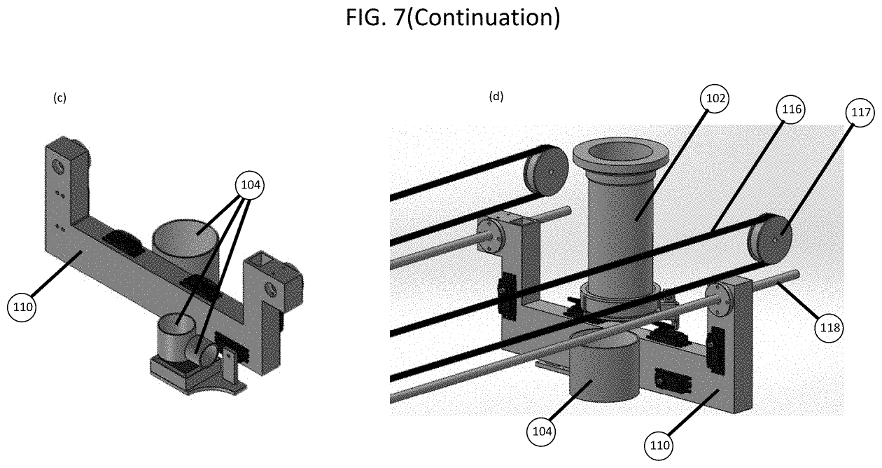

FIG. 7 describes an embodiment of the transport container 104 (FIGS. 7A and 7B depict an arm with rotary movements and FIGS. 7C and 7D depict an arm with linear movements about a horizontal plane). The transport container 104 is mounted on a transport arm 110 driven by an arm actuator 703 (for the rotary arm) or an arm actuator 703 comprised of the belt 116 and pulley 117 system (for the linear arm) which moves it in the horizontal plane. The arm designed for linear movement of FIGS. 7C and 7D glides on linear bearings over a guide rail 118. It will be understood by those well-versed in the art that a linearly moving arm can also be driven by other suitable actuation mechanisms such as rack-and-pinion systems or screws. The transport arm 110 in this embodiment carries not just the transport container 104 but also the dispenser actuator 106. However, the dispenser actuator 106 and the transport container 104 may also be mounted on separate arms 110. In other embodiments, the transport arm 110 may itself consist of a platform mounted on straight rails substantially perpendicular to the main guide rails 118 so as to be capable of movement in the two horizontal dimensions. It will be apparent to those well-versed in the art that the transport arm may combine rotary and linear aspects and may carry a secondary rotary arm on a main linear transport arm 110 or use other such combinations to allow for more freedom of movement in the horizontal plane.

In FIG. 7A is depicted the position and disposition of the ingredient dispenser 103 when it dispenses ingredients into the transport container 104 by displacing the obstruction 202 at the egress orifice of the storage container 102 to which it may be attached by a means for attaching such as a collar 201. When the obstruction 202 is displaced by the dispenser actuator 106, the ingredients fall into the transport container 104. The transport container 104 can also be positioned higher up so it seals itself around the mouth of the ingredient dispenser 103 so that ingredients stop falling out of the ingredient dispenser 103 once the transport container 104 is full. This method can be used to convey measured quantities (by volume) of ingredients to the cooking receptacle 108 where they are cooked. Once the ingredients have been dispensed into the transport container 104, the obstruction 202 can be restored to its blocking position to prevent any further ingredients from being dispensed. The transport container 104 can then be repositioned over the cooking receptacle to which the ingredients are destined by a rotation of the arm 110 driven by the arm actuator 703.

In FIG. 7B is depicted the position and disposition of the transport container 104 when it releases ingredients into the cooking receptacle 108 where they are cooked. The transport container actuator 702 the transport container 104 releases the ingredients either by tilting the transport container 104 as depicted in FIG. 7B or by opening a lid at the bottom of the transport container 104. The ingredients now fall out of the transport container 104 and into the cooking receptacle 108. Thus the ingredients have been conveyed from the storage container 102 to the cooking receptacle 108. The transport container 104 comes into contact with food ingredients, and so needs to be detachable. The transport container 104 can be detached from the arm 110 and thus from the rest of the machine by a means of detaching 701. This allows it to be easily removed for cleaning. The means of detaching 701 can also include a load-cell (a weight sensor) to allow the quantities of ingredients dispensed by the ingredient dispenser 103 to be weighed.

In other embodiments, the transport container 104 may take the form of a chute (a large tube or slide) that is held such that ingredients dispensed by the ingredient dispenser 103 enter into the upper end of the chute and exit the lower end of the chute which is positioned above the cooking receptacle 108 for which the ingredients are destined. This allows the ingredients to be carried under the effect of gravity (possibly assisted by air flow, positive pressure or suction) from the ingredient dispenser 103 through the chute and into the cooking receptacle 108.

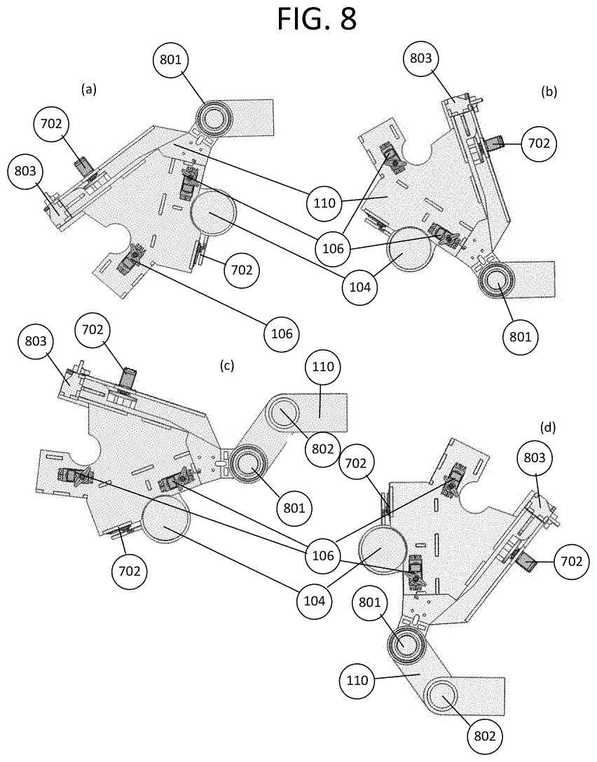

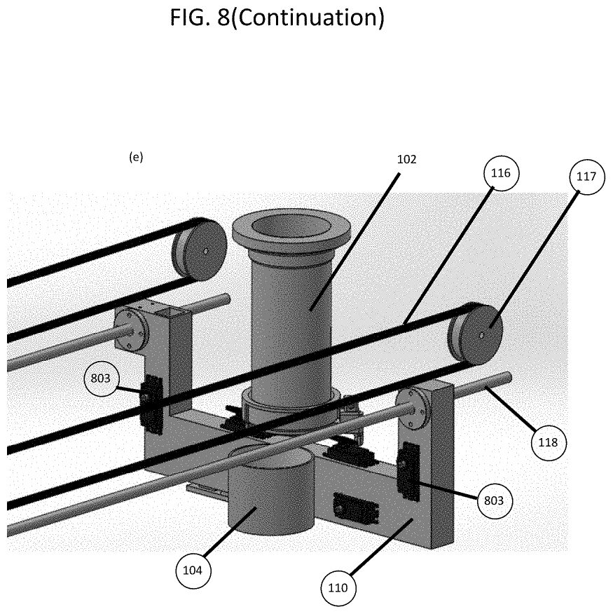

FIG. 8 depicts three embodiments of the transport arm 110 by means of which the dispenser actuator 106, the transport container 104 and the transport container actuator 702 may be supported. The transport arm 110 may also support a manipulator. FIGS. 8A and 8B depict an embodiment of an arm 110 with one hinge 801 (with a vertical axis) about which the arm 110 can swing in the horizontal plane. Since there is only one axis of rotation, the loci of movement of the means of conveying 104 and the dispenser actuator 106 are arcs. The embodiment of an arm shown in FIGS. 8A and 8B can be used in machines where the ingredient dispensers are arranged in an arc in the horizontal plane and therefore can be reached by the arm 110 by a rotary motion about the hinge 801.

FIGS. 8C and 8D depict an embodiment of an arm 110 with two hinges (one of the hinges 801 being close to the ingredient dispenser) and the other 802 being further off. Such an arm can reach and operate ingredient dispensers positioned anywhere in the horizontal plane provided that place falls within a certain distance from the hinge 802. This arm allows a more narrow (shorter distance front to back) shape to be used for the cooking machine which is an advantage given the narrow kitchen counters typically found in most Asian countries.

FIG. 8E depicts an embodiment of an arm 110 that moves along a linear path on a guide rail 118 powered by one or more belts 116 and pulleys 117.

In some embodiments of the movable load bearing member 110, the movable load bearing member 110 is rendered rigid using a locking mechanism 803 before operating the ingredient dispenser. In some embodiments the locking mechanism 803 fixes itself with respect to a rigid part of the body of the machine thereby preventing the movement of the hinges 801 and 802. In some other embodiments, the means for locking 803 obstructs the free rotation of the hinges 801 and 802, thereby rendering the load bearing member 110 rigid. The use of such a locking mechanism permits the use of less powerful means of driving the hinges 801 and 802 since these means of driving the hinges would not have to hold the arm 110 rigid while the dispenser actuator 106 is in operation. For the linear arm, either one or two locking mechanisms 803 are used to render fixed one or both ends of the linear arm as depicted in FIG. 8E.

It will be apparent to those well-versed in the art that the movable load bearing member can also be supported by a set of rails or racks or air cushion or cable and moved along such a support either powered by its own propulsion or driven by belts or externals actuators.

It will be apparent to those well-versed in the art that the movable load bearing member need not even be an arm but can itself be a slider running on a set of rails or multiple sets of rails set at angles to one another. The slider may be powered by its own motors or driven by belts running over pulleys.

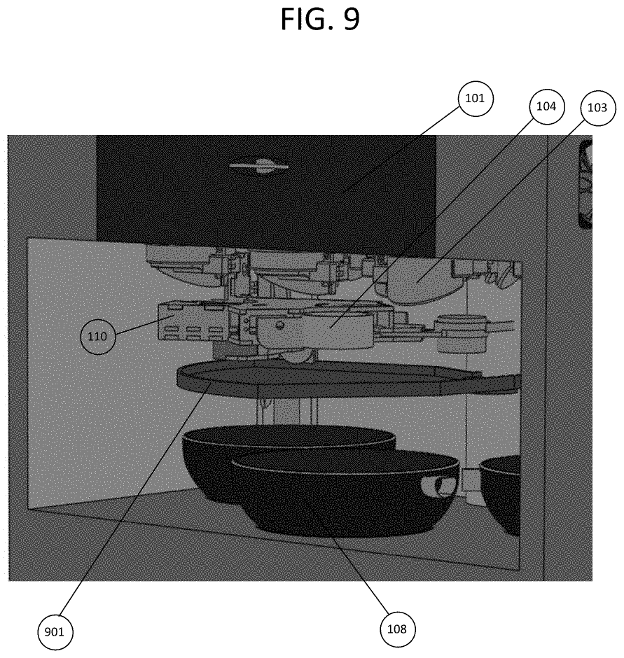

FIG. 9 illustrates one embodiment of a means for collecting ingredients being spilt or splashed and preventing the spilt ingredients from entering any cooking receptacle which they are not intended to enter (a spill guard so to speak). When ingredients are dispensed from the ingredient dispenser 103 into the transport container 104 them to their cooking receptacles 108, some ingredients might spill from the ingredient dispenser 103 or the transport container 104. The spill guard 901 in this embodiment is a tray that can be positioned under the ingredient dispenser 103 being operated to catch any spillage and prevent it from entering a cooking receptacle 108 that the spilt ingredient is not destined for. The spill guard can also take other forms, such as a means for sealing any gaps around the mouth of the transport container 104 or a container positioned underneath and around the transport container 104. The means for preventing ingredients can also be easily detached from the hinge it pivots on and its actuators.

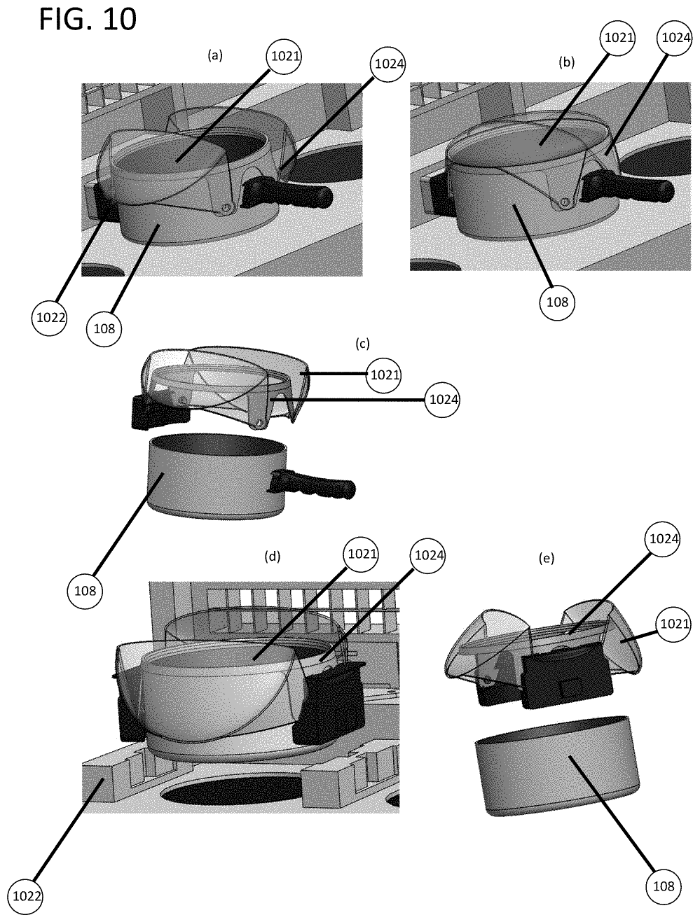

In some embodiments of the cooking apparatus of FIG. 1, the method of cooking used might be baking. In some embodiments, it might be desirable for the temperature of cooking to be raised through the addition of pressure. A mechanism for pressure-cooking ingredients or baking said ingredients in the cooking receptacles 108 is described in FIG. 10.

FIG. 10 illustrates a mechanism for pressure-cooking ingredients or baking said ingredients in the cooking receptacles 108 comprising a lid 1021 which can be lowered onto or closed over a suitable cooking receptacle 108 by an attachment mechanism 1022 as shown in FIGS. 10A-10G. When the raised lid 1021 as shown in FIG. 10F is lowered onto or closed over the cooking receptacle 108, and latched in place using a latching mechanism 1023 as shown in FIG. 10G, the pressure developed in it can result in the pressure-cooking of the contents of the cooking receptacle. The lowering of the lid 1021 can also (optionally assisted by the use of suitable means for supporting the ingredients placed in the cooking receptacle 108), allow for the baking of the contents of the cooking receptacle 108. The lid can also optionally be connected to a collar 1024 which is fitted over a standard cooking receptacle 108.

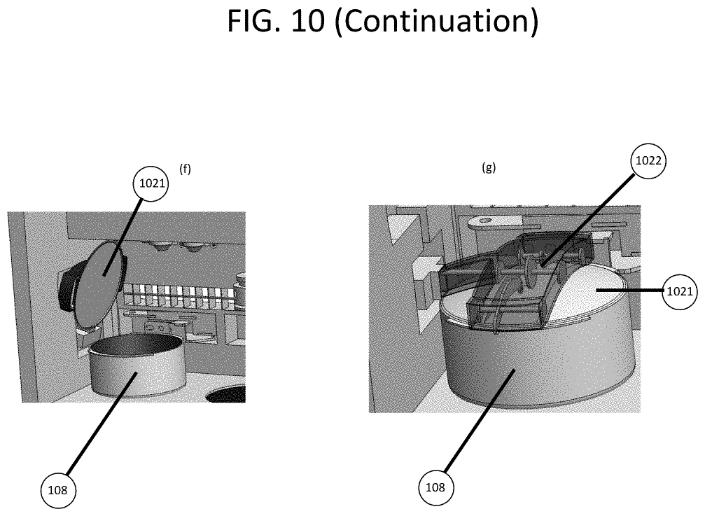

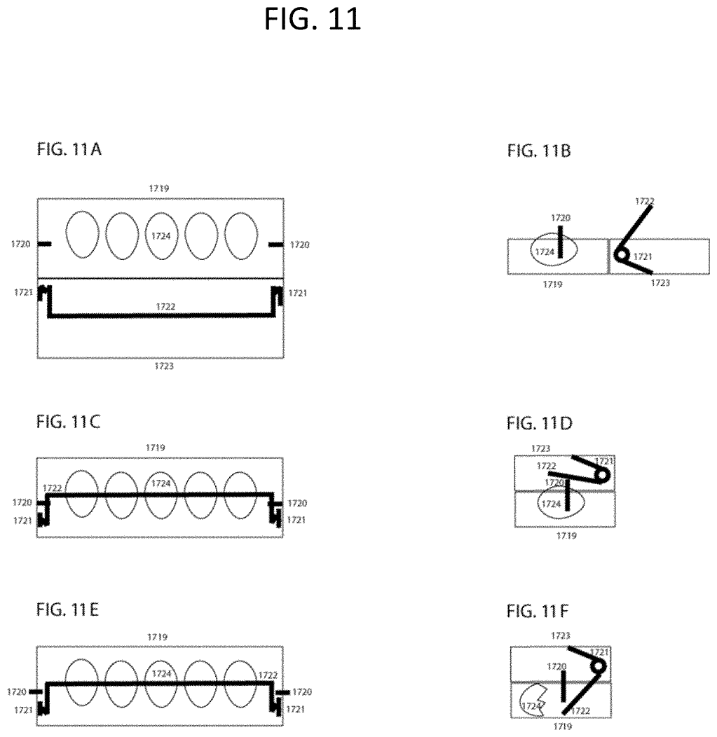

Some dishes require as an ingredient the contents of eggs. Eggs need to be stored whole and their shells broken only when the time for cooking the dish has come. An embodiment of a mechanism for storing eggs 1719 whole and breaking their shells as and when the contents of the eggs need to be added to a dish is illustrated in FIG. 11.

FIG. 11 illustrates an embodiment of a mechanism for storing eggs whole and breaking their shells as and when the contents of the eggs need to be added to a dish, comprising a container 1719 for storing eggs, a lid 1723, a means for breaking egg shells 1722, an actuator 1721 (such as a spring, a motor, or a solenoid) that drives the means for breaking, and a trigger 1720 for releasing the means for breaking at a suitable time. The mechanism is capable of being opened as shown in FIG. 11A to allow the eggs 1724 to be loaded into the container 1719 for eggs. When the lid 1723 is opened, the means for breaking 1722 and actuator 1721 are positioned as shown in FIGS. 11A and 11B. Once the eggs are placed in the container 1719, the lid is closed, setting the actuator 1721 (and if it is a spring, tensing the spring) as shown in FIGS. 11C and 11D. The means for breaking 1722 egg shells is restrained from doing so by the triggers 1720. When the time for adding the contents of eggs 1724 to the dish being cooked has come, the triggers 1720 are activated, releasing the means for breaking 1722 the egg shells as shown in FIG. 11E and 11F. This releases the contents of the eggs 1724 which flow under the force of gravity out of the container 1719 through a set of filters (to prevent pieces of egg shells from being added to the dish) into the cooking receptacle 108 to which the contents of eggs must be added.

In some embodiments of the mechanism for storing eggs and breaking their shells, the means for breaking may further comprise a means for pulling the egg shells apart and obstructing the pieces of egg shells from flowing out with the egg white and egg yolk. Such a means might take the form of a comb-like structure or a brush-like structure or filter.

In order to enable a user to have a hot meal waiting when they reach their home, it would be necessary to preload the cooking apparatus with ingredients before the user leaves for work in the morning, and to trigger the cooking so that the dishes are ready by the time the user reaches their home. This requires a means for remotely controlling the cooking apparatus as illustrated in FIG. 12.

FIG. 12. illustrates an embodiment of a controller used for controlling and of a communication system used for monitoring and commanding the cooking apparatus. These systems comprise the microprocessor in the machine for cooking 1801 and one or more means for communicating 1802 (such as a display and keypad). The microprocessor in the cooking apparatus 1801 awaits commands from the user through the means for communicating 1802 to select the dishes to be cooked and to commence the process of cooking. Once a command to begin the process of cooking has been received from the user, and the cooking has commenced, the microprocessor in the cooking apparatus 1801 governs the sequence of steps required to cook the requisite dishes.

In some embodiments, the communication system is a mechanism for communication over a distance 1802 (such as a cell phone) and optionally, a server 1803 for mediating communications between the microprocessor in the cooking apparatus 1801 and the means for communicating over a distance 1802. In this embodiment, the microprocessor in the cooking apparatus 1801, the means for communicating 1802 and the server 1803 that mediates communications are connected by means of an infrastructure for long-distance communications (such as the internet or a cell-phone network). The microprocessor in the cooking apparatus 1801 awaits commands from the user through the means for communicating over a distance 1802 to commence the process of cooking. Once a command to begin the process of cooking has been received from the user, and the cooking has commenced, the cooking apparatus sends a video of the cooking in progress to the user, that the user can view in the display of the means for communicating over a distance.

In some embodiments of the means for controlling and monitoring the cooking apparatus from a remote location, the cooking apparatus is intended to offer assistance in the stocking of ingredients required for future cooking needs by predicting the consumption of ingredients, and therefore of ingredients that need to be purchased, communicating the same to the user, and with the user's permission coordinating with suppliers 1804 on the user's routes of travel to and from work and other chores to have the ingredients processed and in a form ready for loading into the cooking apparatus.

In some embodiments of the means for controlling and monitoring the cooking apparatus from a remote location, the means for communicating over a distance 1802 is also used as a tool for collaboration to permit other members of the family or guests to provide inputs into a set of dishes to be prepared.

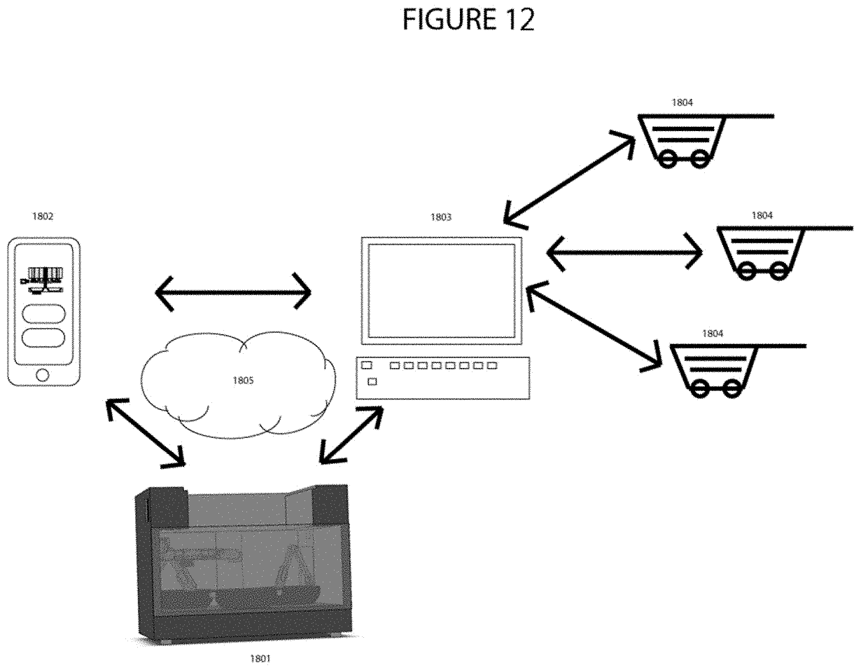

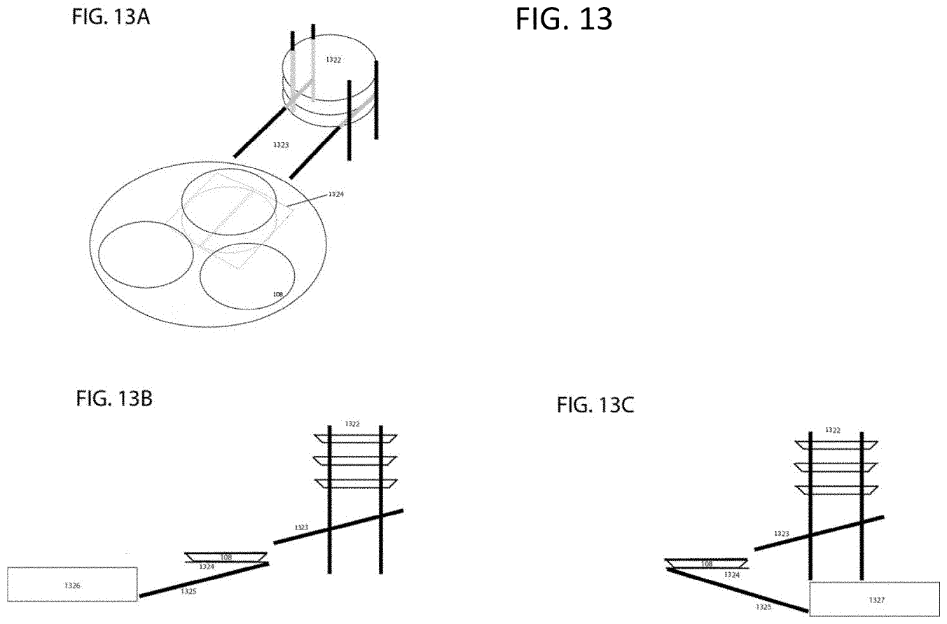

FIG. 13 illustrates one embodiment of a loader, a mechanism for bringing into the machine fresh cooking receptacles 108 and for removing soiled cooking receptacles 108 or cooking receptacles 108 with fully prepared dishes within them. The mechanism for removing cooking receptacles 108 comprises a removable barrier 1324 obstructing an opening large enough to allow cooking receptacles positioned above it to be released under the force of gravity onto a chute, or a conveyer belt which moves vessels off into a storage area for cooked dishes 1326. Soiled dishes can be moved onto a means for transferring 1325 soiled cooking receptacles or cooking receptacles containing cooked dishes from the opening to either the storage area for soiled cooking receptacles 1327 as shown in FIGS. 13B and 13C. The mechanism for loading new cooking receptacles into the machine comprises a dispenser 1322 of clean cooking receptacles 108 and a means for transferring 1323 clean cooking receptacles 108 from the dispenser 1322 to the carousel 107 which could be a slide or a conveyer.

It will be apparent to those skilled in the art that the means for transferring 1323 clean cooking receptacles from the dispenser 1322 to the machine and means for transferring 1325 soiled cooking receptacles or cooking receptacles containing cooked dishes from the opening 1325 to either the storage area for soiled cooking receptacles 1327 or the storage area for cooked dishes 1326 can take the form of a slide, a conveyer, a gripping arm, a chute or any other method of conveying an object from one place to another by the use of a motor or actuator or the force of gravity.

In one embodiment of the dispenser for cooking receptacles 1322 the dispenser can also dispense lids 1021 for said cooking receptacles 108 to be applied to the cooking receptacles. In one embodiment of the mechanism for removing soiled cooking receptacles or cooking receptacles with cooked dishes and for the loading of new cooking receptacles 108 into the machine, the mechanism further comprises a separate dispenser for covers for cooking receptacles.

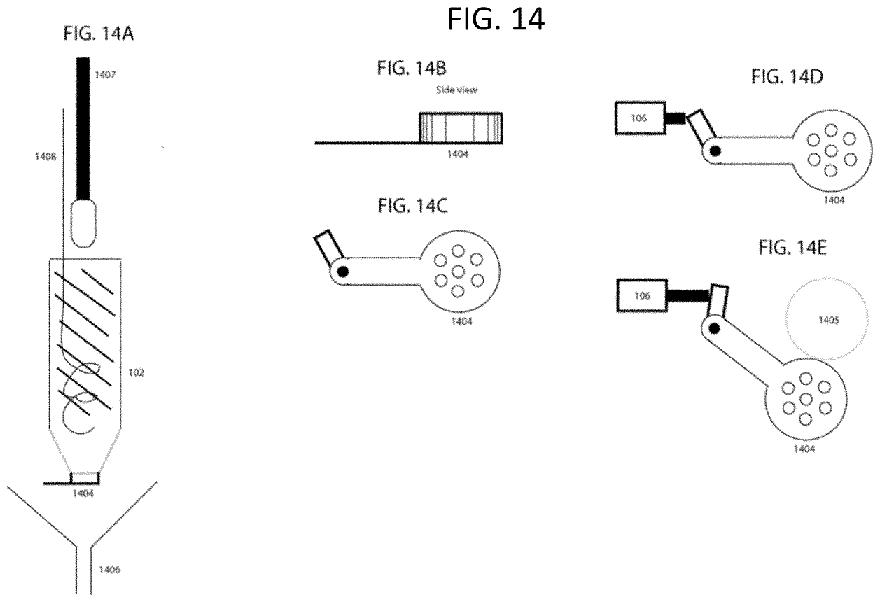

The storage of cereals and pulses in the storage containers 102 poses a further problem. They are best stored dry so that they can be stored for longer durations of time, but they also need to be washed before use. A mechanism for dry storage of solid ingredients and their washing and rinsing immediately prior to cooking is the subject of FIG. 14.

FIG. 14 illustrates an embodiment of a mechanism for storing solid ingredients in a dry environment in a storage container 102 for ingredients and washing said solid ingredients before the ingredients are dispensed into the cooking receptacles 108 for cooking. The mechanism comprises a ingredient dispenser for fluids 1407 used in washing (which might include water and other suitable solvents) and a means for allowing the fluids used in washing to flow out 1404 of the storage container 102 under the force of gravity, where said fluids are collected by a means for collecting 1406 said fluids as shown in FIG. 14A. In one embodiment of the mechanism for washing said solid ingredients, the embodiment is further comprised of a means for agitating 1408 the contents of the storage container 102.

FIGS. 14B through 14E further illustrate the mechanical details of one embodiment of the means for allowing the fluids used in washing to flow out comprising an aperture 1405 through which both fluids may flow out and the solid ingredients may be dispensed, obstructed by a perforated lid 1404 held in place by a spring whose perforations permit the unrestricted flow of fluids used in washing but not of the solid ingredients to be dispensed as shown in FIGS. 14B and 14C. When the solid is being washed the perforated lid 1404 covers the aperture 1405 as shown in FIG. 14D. Once the solid has been washed, and is destined to be dispensed, the dispenser actuator 106 (such as a linear or rotary actuator or motor) moves the perforated lid 1404 away from the aperture 1405 to allow the solid ingredients contained within the storage container 102 to be discharged through the aperture 1405 of the storage container 102 into the cooking receptacle 108 destined to hold the ingredient during the subsequent part of the cooking process, as shown in FIG. 14E.

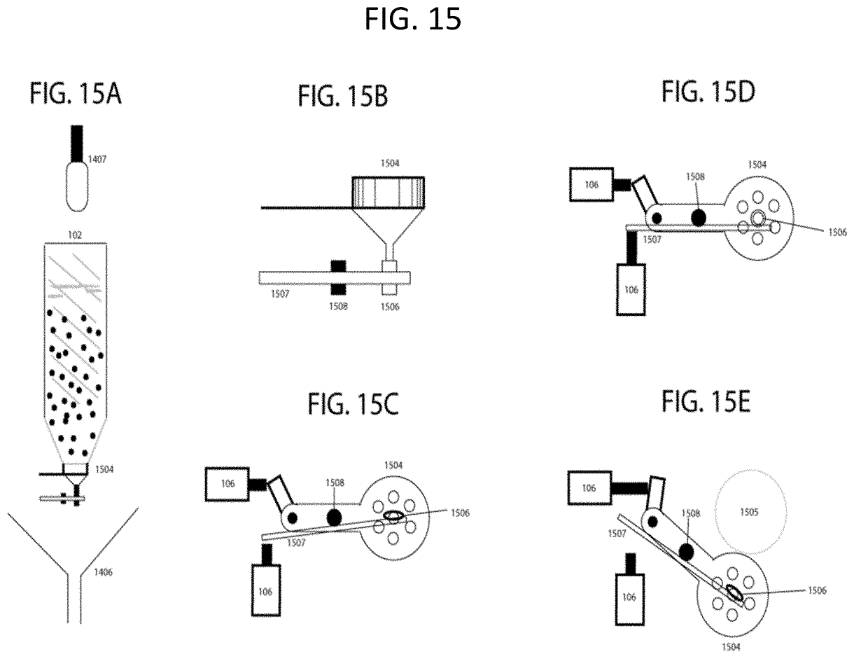

The storage of cut vegetables in the storage containers 102 for solids also sometimes requires that they be stored immersed in a fluid so that they can be stored for longer durations of time without deterioration in flavor or appearance. A mechanism for the storage of solid ingredients immersed in a fluid and the evacuation of the fluid immediately prior to cooking is the subject of FIG. 15.

FIG. 15 illustrates an embodiment of a mechanism for storing solid ingredients immersed in a fluid in a storage container 102 for solid ingredients and evacuating said fluid before the ingredients are dispensed into the cooking receptacles 108 for cooking. The mechanism comprises a means for allowing the fluids (which might include water, oil or other suitable preservatives) used for storing solid ingredients to flow out 1504 of the storage container 102 under the force of gravity where said fluids are collected by a means for collecting 1406 said fluids as shown in FIG. 15A. In one embodiment of the mechanism for storing said solid ingredients immersed in a fluid, the embodiment is further comprised of a ingredient dispenser 1407 for said fluids into the storage container 102.

FIGS. 15B through 15E further illustrate the mechanical details of one embodiment of the means for allowing the fluids used for storing solids to flow out comprising an aperture 1505 through which both fluids may flow out and the solid ingredients may be dispensed, obstructed by a perforated lid 1504 held in place by a spring whose perforations permit the unrestricted flow of fluids used in washing but not of the solid ingredients to be dispensed as shown in FIG. 15B, and a dispenser of fluids 1506 through which the fluids may be evacuated from the storage container 102 whenever required. When the solid is being stored the dispenser of fluids 1506 is held closed by a lever 1507 and a pivot and spring 1508 as shown in FIG. 15C. Once the time has come when the solid is destined to be dispensed, the liquid in which the solid is stored is first evacuated by the dispenser actuator 106 which moves the lever 1507 in such a way as to enable the dispenser of fluids 1506 to operate, as shown in FIG. 15D. Once the liquid in which the solids are stored has flowed under the force of gravity through the dispenser 1506 of fluids, the dispenser actuator 106 (such as a linear or rotary actuator or motor) moves the perforated lid 1504 away from the aperture 1505 to allow the solid ingredients contained within the storage container 102 to be discharged through the aperture 1505 of the storage container 102 into the cooking receptacle 108 destined to hold the ingredient during the subsequent part of the cooking process, as shown in FIG. 15E.

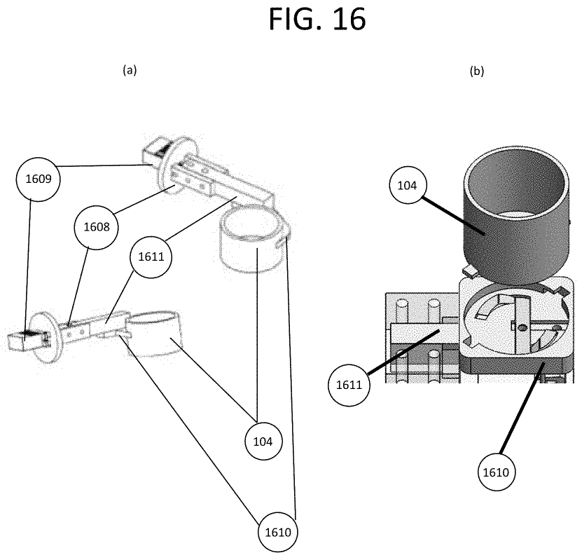

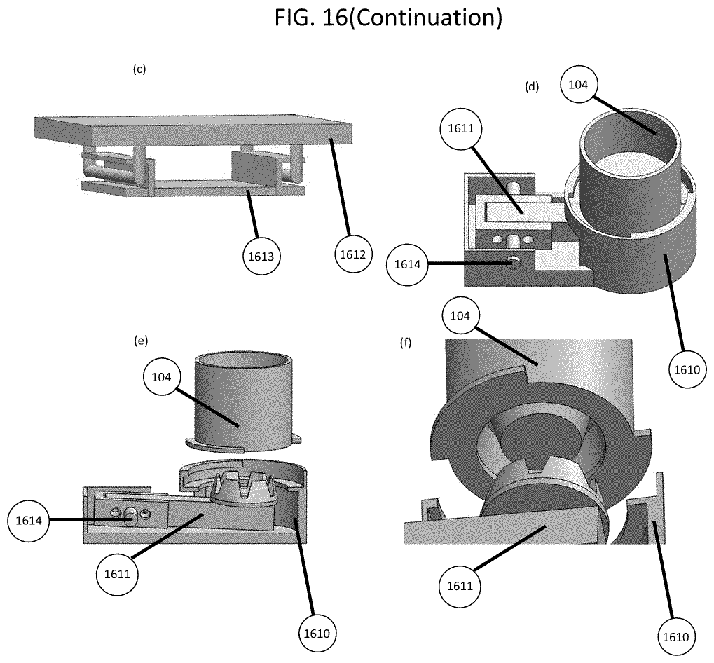

FIG. 16A depicts one embodiment of a part of a mechanism for dropping controlled quantities of food ingredients where the quantities are controlled by volume or by weight. The mechanism consists of a volume sensor (measuring cup which in this case is also the transport container) 104 (and optionally also a means for measuring by weight 1611). The volume sensor (measuring cup) doubling as the transport container 104 works by being moved into position under any orifice from which uncontrolled quantities of food ingredients are being dispensed. The volume sensor (measuring cup) doubling as the transport container 104 receives food ingredients till it is full. The flow of food ingredients is then interrupted and then the volume sensor (measuring cup) 104 is moved (again by a hinge 1608 powered by an actuator 1609) to face downwards, thus dispensing a measured quantity of said food ingredients.

The weight sensor 1611 (typically a load-cell) is used in conjunction with the volume sensor (measuring cup) 104 to weigh powders (such as spices) or fluids that are dispensed in uncontrolled quantities into the volume sensor (measuring cup) 104 provided the flow of ingredients is slow enough (in small enough increments) to permit weight measurements to be taken by 1611. When the desired weight is reached, the flow of ingredients into the volume sensor (measuring cup) 104 is interrupted and the volume sensor (measuring cup) 104 is rotated upside down, thus dispensing an accurate quantity (by weight) of the desired ingredient.

In volume sensors, the weight sensor 1611 can be dispensed with and the coupling 1610 directly connected to the hinge 1608. The volume sensor (measuring cup) 104 can also be detached from the hinge 1608 by means of the coupling 1610 allowing it to be easily detached for washing. FIG. 16B illustrates one embodiment of a quick-release mechanism in the coupling 1610 that allows for the quick and easy detachment of the transport container for washing.

When the transport container 104 rests on a weight sensor 1611 and needs to be detached from the latter, care needs to be taken to not overload the weight sensors (which can be very sensitive and fragile) and thereby damage it. So, a loose coupling consisting of a top plate 1612 and a bottom plate 1613 that are loosely physically coupled (as shown in FIG. 16C) is interposed between the quick release coupling 1610 and the load cell 1611. The presence of the loose coupling allows the weight sensor to be parked and protected when not in use (by using grippers to hold the top plate 1612 immovably in place) so that it is cannot be damaged when the transport container 104 is handled while being removed. FIG. 16C shows that the plates 1612 and 1613 can move a certain distance from each other in all three dimensions (in translation and rotation) without fully detaching from each other. This permits the firm gripping of the top plate 1612 by grippers without any danger to the weight sensor (load cell), thereby protecting the weight sensor from excessive loads during handling of the transport container 104. depicts a more detailed view of the loose coupling used to connect the transport container 104 to the weight sensor.

FIGS. 16D, 16E and 16F depict yet another form of a loose coupling consisting of a hinge 1613 which allows the weight sensor (load cell) 1611 to be loosely coupled to the quick-release coupling 1610 which also acts as a casing for the weight sensor 1611. The casing 1610 is restricted from moving any lower than a certain limit, so the weight sensor 1611 can be lowered and rested upon the casing 1610 when not in use as shown in FIG. 16E. When the weight sensor 1611 is in use, it is raised as shown in FIG. 16F till the casing 1610 rests upon it. The ingredients are weighed by subtracting the weight of the casing from the weight of the ingredients plus the weight of the casing. When the weight sensor (load cell) 1611 needs to be parked, it is lowered to rest on the floor of the casing 1610 and allowed to move freely with the casing. With suitable cushioning between the casing 1610 and the weight sensor 1611, the latter will be substantially protected from being overloaded.

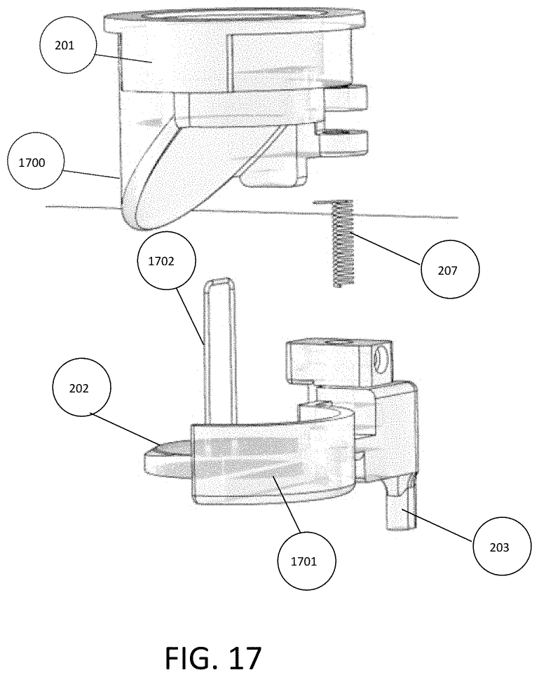

FIG. 17 depicts certain details of one part of a mechanism for dispensing controlled quantities of food ingredients, namely the obstruction (here a lid) 202 and the collar 201 for attaching the same to the storage container 102. The obstruction 202 and the handle 203 can in some embodiments also comprise a skirt 1701 designed to prevent food ingredients from scattering (in terms of the horizontal distance travelled by the food ingredients) far from the egress orifice through which they are dispensed (in this embodiment a skirt). The obstruction 202 can also further comprise a rake or stirrer 1702 for disturbing food ingredients accumulated or jammed near the egress orifice and thereby causing food ingredients to flow better through the orifice. The dispenser collar 201 in some embodiments further comprises a skirt 1700 for preventing food ingredients from scattering (in terms of the horizontal distance travelled by the food ingredients) far from the orifice through which they are dispensed. The means for preventing the scattering of dispensed food ingredients 1700 and 1701 together keep the food ingredients from falling on any mechanism of the cooking robot that lie below and at a small horizontal distance from the orifice from which the ingredients are dispensed. The rake for disturbing food ingredients near the orifice through which they are destined to be dispensed helps reliable dispensing under gravity of hard-to-dispense substances like turmeric powder.

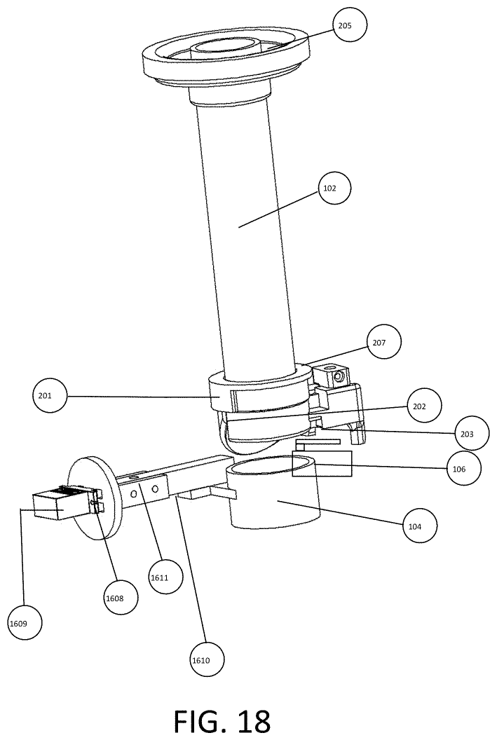

FIG. 18 illustrates a mechanism for dropping controlled or uncontrolled quantities of food ingredients featuring a storage container 102 with an egress orifice at its lower end, at which can be found a collar 201 for attaching to the storage container an obstruction (here a lower lid) 202 which keeps the ingredients placed in the storage container from falling out until said lower lid is opened. The lid is kept closed by a spring 207 lid and can be opened by a handle 203. The handle 203 can be operated by a dispenser actuator 106 such as a motor or a solenoid. In this design, said dispenser actuator 106 can be easily separated from the rest of the ingredient dispenser as it is in no way tethered to the rest of the ingredient dispenser, and only needs to come in contact with the rest of the ingredient dispenser when opening the lid using the means for opening, as can be seen from FIG. 18. The ingredient dispenser might optionally make use of a volume sensor (measuring cup) 104 (and optionally also a means for measuring by weight 1611). The volume sensor (measuring cup) 104 works by being rotated into position (by a hinge 1608 which is in turn driven by an actuator 1609) under the lower orifice of said storage container 102 to receive any ingredients that fall out of said lower orifice when the obstruction 202 in the ingredient dispenser 103 opens till it is full. The obstruction 202 of the ingredient dispenser 103 is then closed and the volume sensor (measuring cup) 104 is rotated to face downwards, finally dispensing a measured quantity of said food ingredients. It can be seen that the volume sensor (measuring cup) 104 can be easily detached from the storage container 102 and obstruction 202 of the ingredient dispenser 103 because it is nowhere attached to them. The volume sensor (measuring cup) 104 can also be detached from the hinge 1608 by means of the quick-release clasp 1610 allowing it to be washed alone. The weight sensor 1611 can be dispensed with and the quick-release clasp 1610 directly connected to the hinge 1608 in some embodiments of the dispenser. The weight sensor 1611 (typically a load-cell) is used in conjunction with the volume sensor (measuring cup) to weigh powders or fluids that are dispensed into the volume sensor (measuring cup) 104 in small quantities incrementally by small movements of the obstruction 202. When the desired weight is reached, the volume sensor (measuring cup) 104 is rotated upside down to finally dispense an accurate quantity (by weight) of the desired ingredient. The means for covering the opening 205 (in this depiction a plug) larger than the appropriate cross-section of the storage container is required to position the dispenser firmly in its slot in a cooking robot while allowing the unimpeded insertion of the dispenser into the cooking robot. It will be apparent to those skilled in the art that the plug can be positioned on the side should the dispenser be designed to be removed from the side of a cooking robot, or at the bottom should that be the preferred side from which the dispenser is to be removed.

It will be apparent to those skilled in the art that the ingress orifice of the storage container for ingredients 102 can be covered by an upper lid to protect the ingredients therein. It will also be apparent to those skilled in the art that neither the storage container not its orifices and other parts are likewise limited to a circular cross-section or the specific length or orientation shown in FIG. 18. We have described above the parts of the dispenser according to FIG. 18 and described their operation.

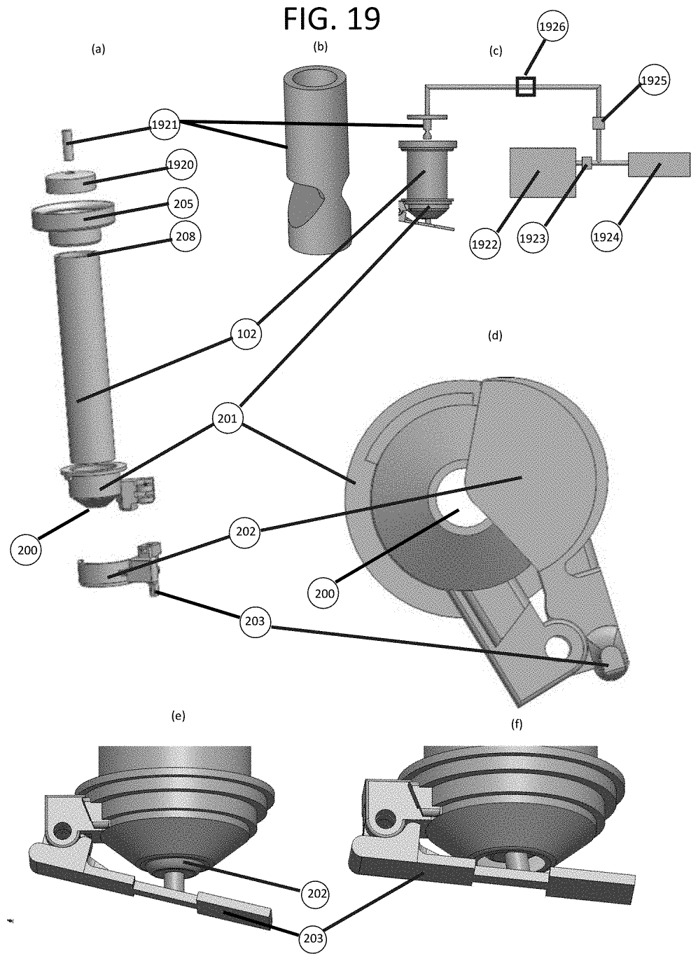

FIG. 19 illustrates an embodiment of yet another type of ingredient dispenser that uses pressurized air for dispensing quantities of food ingredients that might be difficult to dispense only with the assistance of gravity. The pressurized air ingredient dispenser features a storage container 102 with an ingress orifice 208 through which ingredients can be loaded into the storage container, an egress orifice 200 at its lower end, at which orifice can be found a collar 201 for attaching to the storage container a removable obstruction 202 (in this case a lid) which keeps the ingredients placed in the storage container from falling out until said obstruction 202 is displaced. The obstruction is kept in its obstructing position by a spring 207 and can be opened by a handle for opening 203 the same. The handle for displacing/removing the obstruction 203 can be operated by a dispenser actuator 106 such as a motor or a solenoid. At the same time as the obstruction is removed, a blast of pressurized air is released into the storage container through an air inlet 1921 (here shown introduced through the lid 1920 of the ingress orifice) such that the ingredients in the storage container are forced out of the egress orifice 200. FIG. 19B shows the structure of the air inlet 1921 which is designed so that the stream of air is deflected and directed to the sides of the storage container 102.

FIG. 19C illustrates the system for storing pressurized air for use in the pressurized air dispenser, comprising a compressor (a pump) 1922 which pumps air through a non-return value 1923 into a storage container 1924 for pressurized air. The pressurized air is held in the storage container 1924 and released through a regulator 1925 whenever required by a solenoid-controlled orifice 1926 into the air inlet 1921.

FIG. 19D is a bottom view (looking up at the bottom of the said dispenser) and shows the egress orifice 200 and the obstruction 202 and the handle 203 by which the obstruction is removed. FIGS. 19E and 19F depict an alternative design of an obstruction (here a plug) 202 and the handle 203 by which the obstruction is removed.

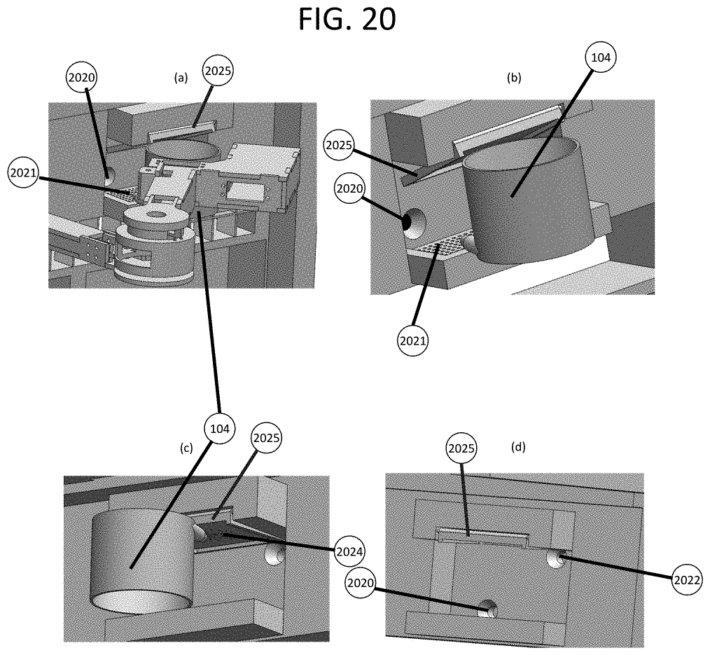

FIG. 20 illustrates a system for rinsing grains and pulses. One of the parts thereof is a specialized transport container 104 (with perforations at the bottom to let out water) into which the grains or pulses (which are stored dry) are dropped from the storage containers. The specialized transport container 104 is then moved into a rinsing enclosure where water is pumped into transport container from a water inlet 2020 such that it swirls around before it exits through perforations at the bottom of the transport container and flows out through the drain 2021 at the bottom of the rinsing enclosure.

Optionally a spring-loaded lid 2025 keeps the grains from being spilt by the introduction of the water for rinsing.

The specialized transport container 104 can itself be cleaned of any leftover grains or pulses by being introduced into the same or similar enclosure upside down. Cleaning water is introduced from the second water inlet 2022 and optionally from the spring-loaded lid 2025 through the perforations 2024 therein.

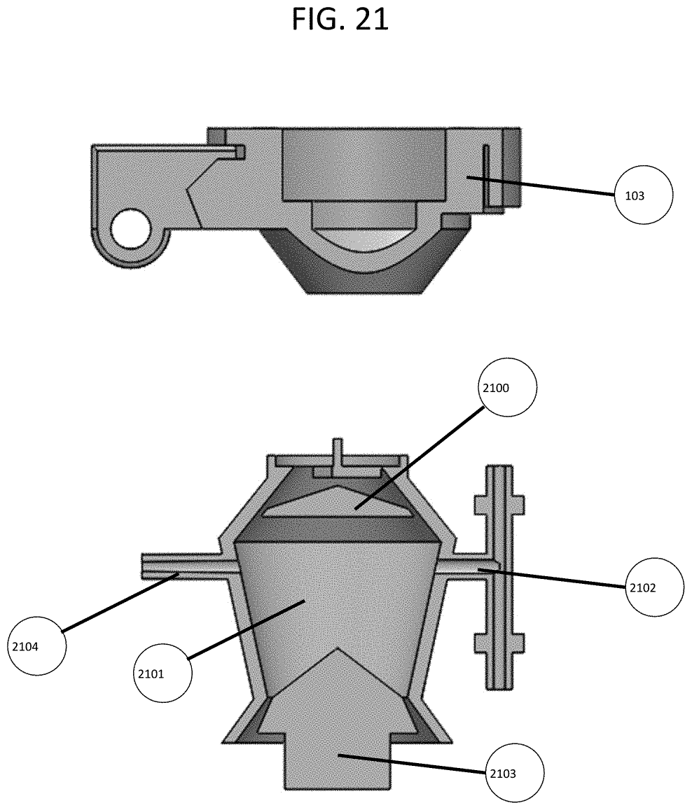

FIG. 21 illustrates an embodiment of yet another type of ingredient dispenser 103 that uses negative air pressure (suction) for dispensing quantities of food ingredients that might be difficult to dispense only with the assistance of gravity. The suction ingredient dispenser features an ingredient dispenser 103 below which is disposed a suction mechanism consisting of one unidirectional valve 2100 through which, when air is sucked out by a vacuum pump 2102, ingredients in powder form are drawn into its cavity 2101. The suction mechanism also has a second lower unidirectional valve 2103 through which, when air is blown into the suction mechanism through the pump attached to air inlet 2104, the powders in the cavity are ejected out the bottom and into a transport container positioned below it.

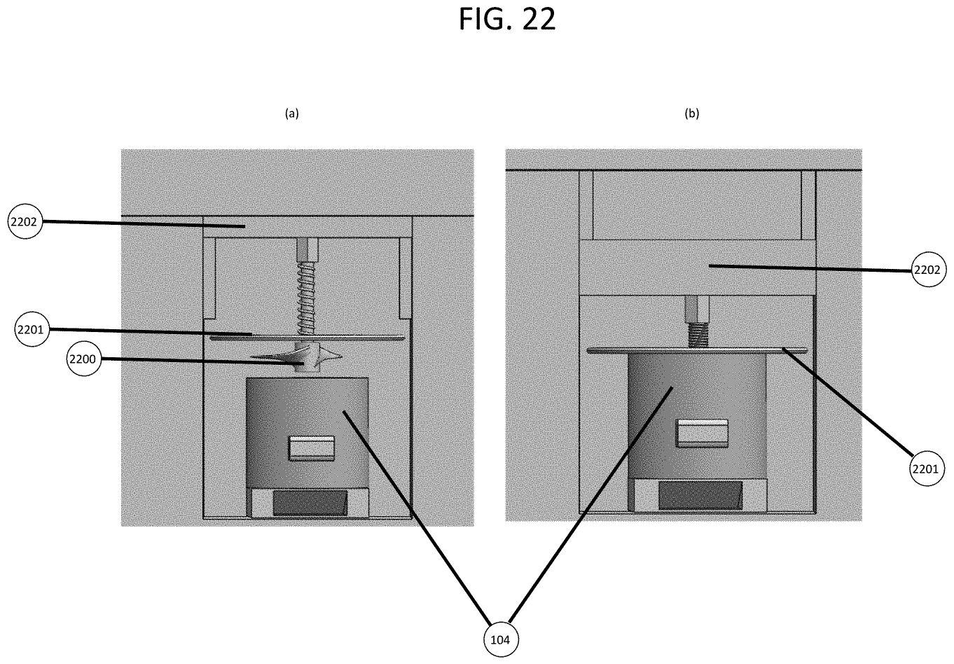

Grinding is an important component of preparing gravy dishes in Indian cuisine. FIG. 22 illustrates a system for grinding ingredients. One of the parts of the system for grinding is a transport container 104) into which the ingredients to be ground have been dispensed from the storage containers. The transport container 104 is then moved into a grinding enclosure where a grinding blade 2200 is lowered into transport container 104 by means of a lift 2202 while a lid 2201 is placed on it by the same movement.

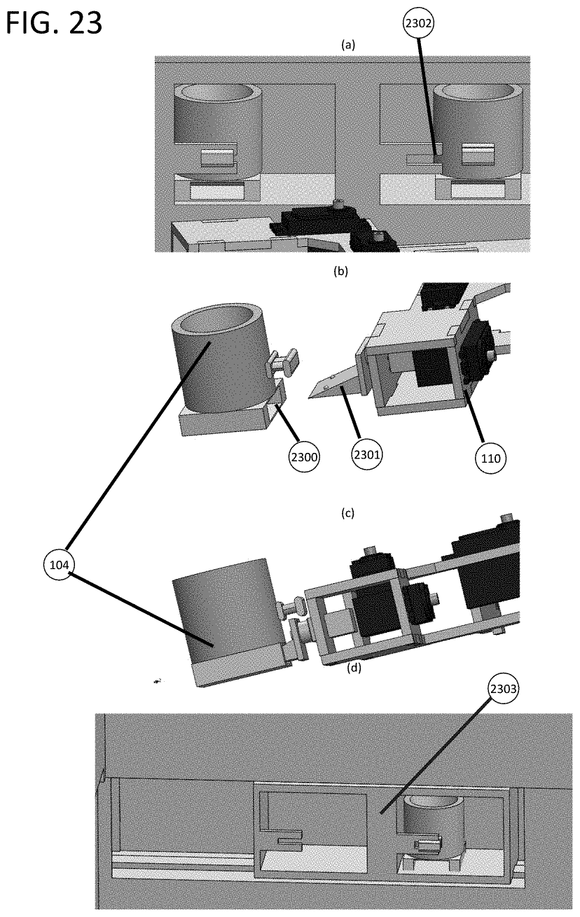

FIG. 23 illustrates a container storage module 2303 where clean transport containers 104 can be stored until they are needed and soiled transport containers 104 can be deposited. The transport arm 110 equipped with a protrusion 2301 is maneuvered so that the protrusion 2301 fits into the slot 2300 in the transport container 104 as shown in FIGS. 23B and 23C. The protrusion 2301 has a spring-loaded latch which binds the transport container 104 to the arm 110. The transport container 104 can be detached by sliding it into its slot in the container storage module 2303 and withdrawing the arm 110 whereupon the spring loaded latch will release the transport container 104. The transport container 104 is kept from sliding out of position by the notch 2302. In some embodiments, the container storage module 2303 can slide from side to side to facilitate the attachment or detachment of the transport containers 104 to the transport arm 110 as shown in FIG. 23D.

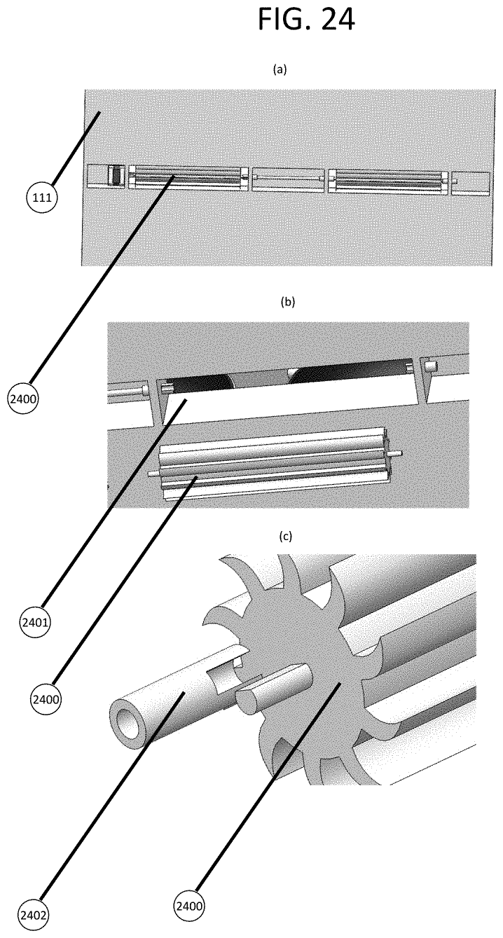

FIG. 24 describes an embodiment of the fan 112 installed in the housing 111 to create an air curtain to evacuate fumes produced during cooking. In this embodiment the fan 111 is a cylindrical fan 2400 which can be fitted into a suitable slot 2401. The cylindrical fan 2400 draws air axially and propels it all directions perpendicular to its axis. By enclosing all directions except the intended direction in which air is to be blown, the cylindrical fan 2400 can be used to create an air flow to evacuate fumes from within the housing 111. One advantage of using a cylindrical fan is that it is easy to remove from its slot 2401 for cleaning by pulling apart the spring-loaded connector 2402 that attaches it to an actuator that turns its blades.

We have described above the parts of the dispenser according to FIG. 24 and described their operation.

It will be apparent to those skilled in the art that while the disclosure above describes the dispenser in the context of dispensing food ingredients, the dispenser can also be used to dispense a variety of other substances.

It will also be apparent to those skilled in the art that while the disclosure above describes a machine of small enough size to fit on a counter-top, and therefore fit for use as a home cooking robot, the machine can be built at a large enough scale to be used in a factory or an industrial kitchen.

While a full and complete disclosure of the preferred embodiments of the invention has been provided above, various modifications and equivalents will occur to those skilled in the art given the benefit of this disclosure. It is to be understood that the invention is not intended to be limited only to the specific examples and embodiments disclosed herein.

1. A machine for cooking food comprising:
a plurality of storage containers for holding ingredients for use in the preparation of cooked dishes;
at least one cooking receptacle configured to hold ingredients while they are being heated in the course of cooking;
an ingredient dispenser disposed upon each of said storage containers and configured so as to let ingredients fall out when desired in a controlled manner;
a dispenser actuator disposed so as to be able to drive said ingredient dispenser;
a transport container configured to receive the ingredients as the ingredients fall out from a corresponding one of said plurality of storage containers and to convey the ingredients to said at least one cooking receptacle;
a transport arm upon which is placed said transport container and dispenser actuator, said transport arm being configured to be driven by an arm actuator;
a container connector disposed between said transport container and said transport arm and configured to attach or detach said transport container from said transport arm;
a heater operable to heat said at least one cooking receptacle;
a manipulator operable to be used to manipulate the ingredients in order to prepare them for cooking disposed upon a support;
a manipulator connector configured to easily attach or detach said manipulator from said transport arm or manipulator arm;
a controller configured to control said heaters, manipulators and actuators; and
a communication system configured to allow a user to communicate with said controller,
wherein said arm actuator is operable to drive said transport arm only along a horizontal plane to minimize power consumption in conveying ingredients from one of said plurality of containers to said at least one receptacle,
wherein said arm actuator is designed to drive said transport arm such that said transport container or one end of said transport container can be disposed substantially directly below a corresponding one of said plurality of storage containers such that the ingredients, when dispensed from the storage container can be caused to fall into said transport container without having to be lifted against the force of gravity,
wherein the movements of said transport arm and said another transport arm in a different plane are capable of bringing said transport container or one end of said transport container substantially directly above a cooking receptacle such that the ingredients can be caused to fall into that cooking receptacle without having to be lifted against the force of gravity,
wherein said plurality of storage containers, said ingredient dispensers, said at least one cooking receptacle, said transport container and said manipulator are easily detachable from the rest of the machine to facilitate their cleaning; and
said ingredient dispensers are all arranged in one horizontal plane or a small number of horizontal planes to facilitate their operation by a small number of dispenser actuators disposed upon a suitable support such as said transport arm so as to be capable of moving to different positions in horizontal planes thereby reducing their cost.

2. The machine for cooking food according to claim 1, wherein each storage container of said plurality of storage containers contains an input opening through which ingredients are destined to be loaded into the storage container, and an output opening through which ingredients are destined to fall out of the storage container,
wherein said dispenser actuator is one of a motor, solenoid, a linear actuator operating in conjunction with one or more of levers, gears, pulleys, belts and chains,
wherein said arm actuator is one of a motor, solenoid, and a linear actuator operating in conjunction with one or more of levers, gears, pulleys, belts and chains,
wherein said support is one of a stand, a wall, said transport arm and a separate manipulator arm, wherein said manipulator is one of a stirrer, a whisk, a scoop, a sieve, a grinder, a mincer, a mixer, a washer, a rinsing mechanism and a blender,
wherein said machine further comprises:
a weight sensor disposed between said transport container and said transport arm to enable measurement of the weights of ingredients in said transport container; and
a loose coupling configured to protect said weight sensor during the process of attaching and detaching said transport container from said transport arm.

3. The machine for cooking food of any of claim 1, wherein said ingredient dispenser comprises:
an obstruction configured to obstruct said output opening, wherein said obstruction is one of a lid, a plug, a stopper, a cap, a slider, a peg, a lever and a pinch-cock.
an obstruction actuator for displacing said obstruction such that it does not obstruct said output opening so that said ingredients may be dispensed out of a corresponding storage container of said plurality of storage containers, wherein said obstruction actuator can be separated easily from the rest of the dispenser; and
an upper cover disposed to cover said input opening and to protect the contents of said corresponding storage container.

4-5. (canceled)

6. The machine for cooking food of claim 1, further comprising a rinsing mechanism configured to clean ingredients such as grains and pulses that require rinsing before use in cooking.

7. The machine for cooking food according to claim 6, further comprising a grinder destined to be used to grind ingredients to be used in cooking.

8. The machine for cooking food according to claim 7, further comprising a lid disposed to cover said cooking receptacle such that it serves certain additional purposes, wherein said additional purposes are one of controlling the escape of fumes and vapors to enable the performance of tasks such as steaming and baking, increasing the pressure within said cooking receptacle in a controlled manner to enable the cooking of ingredients at an elevated temperature and pressure, and preventing the unintended contact of the contents of the receptacles with undesirable things including dust, insects, animals and young humans.

9. (canceled)

10. The machine for cooking food according to claim 8, further comprising a housing designed to prevent the unintended contact of food ingredients, cooked food and parts of the machine with undesirable things including dust, insects, animals and young humans.

11. The machine for cooking food according to claim 10, further comprising a plurality of transport arms, each driven by one of said arm actuators and operating in a different horizontal plane of movement, such that each of said transport arms can transfer ingredients from its own transport container or manipulator to a lower transport arm or to said cooking receptacle, and accept ingredients into its own transport container or manipulator from a higher transport arm or said storage containers.

12. The machine for cooking food according to claim 11, wherein said manipulator can be dipped into said at least one cooking receptacle so that the ingredients are manipulated while contained within said cooking receptacle.

13. The machine for cooking food according to claim 12, wherein said manipulator is disposed so that the ingredients are first dispensed from said transport container into said manipulator and suitably manipulated in said manipulator before being allowed to fall from said manipulator into said transport container.

14. The machine for cooking food according to claim 13, wherein the manipulator is configured to be applied to ingredients within said transport container such that the ingredients are manipulated within said transport container itself, wherein the types of manipulations include grinding, whisking and blending.

15. The machine for cooking food according to claim 14, wherein said transport arm comprises at least one locking mechanism configured to hold the transport arm rigidly at certain positions so that said arm actuators do not have to do the work of keeping it in position.

16. The machine for cooking food of claim 8, further comprising:
a physical grouping of said storage containers containing indicators marking the position of each storage container to help with identifying individual storage containers for loading,
wherein said physical grouping of storage containers is easily detachable from the rest of the machine for cooking food.

17. The machine for cooking food according to claim 16, further comprising sensors configured to measure various physical parameters related to the cooking process, wherein said physical parameters include volumes, weights, temperatures, pressures, gaseous emissions, smells, tastes, softness, viscosity, sounds, as well as visual appearances in the form of video streams and static images.

18. (canceled)

19. The machine for cooking food according to claim 17, further comprising a manipulator storage module containing manipulators, configured to allow said transport arm to attach to and remove any clean manipulator stored within it, and detach and leave in it any manipulator soiled during the process of cooking.

20-21. (canceled)

22. The machine for cooking food of claim 17, wherein said ingredient dispenser further comprises a volume regulator configured to limit and regulate by volume the quantities of ingredients dispensed.

23. The machine for cooking food according to claim 22, wherein said ingredient dispenser further comprises a weight sensor configured to measure and regulate by weight the quantities of ingredients dispensed,
wherein said weight sensor is easily detachable from the rest of said ingredient dispenser.

24. The machine for cooking food according to claim 23, wherein said obstruction further comprises an ingredient flow enhancer for causing food ingredients to more easily exit the storage container in which they are contained,
wherein said flow enhancer is one of a rake, a stirrer and a vibrator.

25. The machine for cooking food according to claim 24, wherein said ingredient dispenser further comprises a skirt configured to prevent food ingredients from scattering in an undesirable manner.

26. The machine for cooking food according to claim 25, further comprising a fan configured to evacuate fumes and vapors produced by the cooking process from said housing and draw fresh air into said housing.

27-29. (canceled)

30. The machine for cooking food according to claim 26, wherein the machine is modular, and wherein said controller, said manipulators, said heaters and said housing containing said storage containers and ingredient dispensers are sold separately and assembled into one machine.

31. The machine for cooking food according to claim 30, further comprising:
a recording mechanism to record cooking instructions destined to be given to it by voice or through said communication system and to transform said cooking instructions into a recipe that users can share and any similar machine can execute;
an algorithm to convert the recipe designed for a first number of people into a recipe for a second number of people;
an algorithm to convert the recipe designed for a first ambient air pressure and humidity into a recipe for a second ambient air pressure and humidity; and
an internet communicator configured to allow the machine and its user to be part of a social network involving similar machines and other users, thereby allowing said users to collaborate, to share recipes and videos and to cook dishes remotely and as a community.

32. A machine for cooking food comprising:
a storage container for holding ingredients for use in the preparation of cooked dishes;
a cooking receptacle for holding ingredients while the ingredients are being heated in the course of cooking;
an ingredient dispenser disposed upon said storage container and configured so as to let ingredients fall out when desired in a controlled manner;
a dispenser actuator disposed so as to be able to drive said ingredient dispenser;
a transport container configured to receive the ingredients as the ingredients fall out from said storage container and to convey the ingredients to said cooking receptacle;
a transport arm upon which is placed said transport container and dispenser actuator, said transport arm being configured to be driven by an arm actuator; and
a container connector disposed between said transport container and said transport arm and configured to attach or detach said transport container from said transport arm,
wherein said storage container, said ingredient dispenser, said cooking receptacle, and said transport container are easily detachable from the rest of the machine to facilitate their cleaning,
wherein said arm actuator is operable to drive said transport arm only along a horizontal plane to minimize power consumption in conveying ingredients from said storage container to said cooking receptacle.
